(19) United States
(12) Patent Application Publication
(10) Pub. No.: US 2003/0146346 A1
(43) Pub. Date: Aug. 7, 2003

(54) Tubular members integrated to form a structure

(76) Inventor: W. Cullen Chapman Jr, Hermosa Beach, CA (US)

Correspondence Address: Sung I Oh, Squire Sanders & Dempsey, 14th Floor, 801 South Figueroa Street, Los Angeles, CA, 90017-5554, US

(21) Appl. No.: 10/181,592

(22) PCT Filed: Jan. 22, 2001
(86) PCT No.: PCT/US01/02048

(51) Int. Cl. B64C 1/00; B64C 3/00; B64C 5/00

(52) U.S. Cl. 244/123

(57) ABSTRACT

Integrally stiffened and formed, load carrying structures comprising a plurality of elongated thin-walled tubes placed co-extensively in a complementary side-by-side fashion which together form a hollow structure having a desired external contour. Integral skins forming the external and internal surfaces of the structure cooperatively therewith. The structure can be formed with an underlying internal support member spanning the interior of the load carrying structure, thereby connecting opposite sides of the structure together. Also, each of the tubes are wound with fibers in controlled orientations generally paralleling the direction of the loads applied to the tubes to optimize the strength to weight ratio of the tubes. Still a number of embodiments are disclosed to couple two structures together. In addition, an apparatus and method is disclosed to form a window opening within the fuselage and to install a window covering that is both time saving and cost efficient.

### BACKGROUND OF THE INVENTION

1. Field of the Invention

This invention relates generally to a load carrying tubular member and, more particularly to a tubular member that has been wound with specific cross-section fibers in a controlled orientation to optimally carry the load applied to the member, where a number of load carrying members can be assembled to cooperate in forming a body of revolution.

2. Description of the Prior Art

Over the past two decades, the use of fiber composite materials in aircraft structures has gained popularity. As a result, modern airframes incorporate structural components made of composite materials to form aircraft wing structures, rotor blades, fuselage segments and the like as substantial weight savings can be achieved due to the superior strength-to-weight ratio of fiber composite materials as compared with the conventional materials of aircraft construction such as metal alloys. By replacing structural components previously formed of metal alloys with similar versions of the same component formed of composite material a respective weight savings in the order of 25 to 30 percent is generally considered to be achievable.

In general, composites include a reinforcing material suspended in a “matrix” material that stabilizes the reinforcing material and bonds it to adjacent reinforcing materials.

Composite parts are usually molded, and may be cured at room conditions or at elevated temperature and pressurized for greater strength and quality.

Most of the composites used in aircraft structures comprise of filament reinforcing material embedded in a polymer matrix. A primary advantage associated with the use of filament composites is that their structural properties may be tailored to the expected loads in different directions. Contrary to metals which have the same material properties in all directions. filament composites are strongest in the direction the fibers are running. If a structural element such as a spar is to carry substantial load in only one direction, all the fibers can be oriented in that direction. This characteristic of filament composite provides for exceptional strength-to-weigh ratios and offers a tremendous weight savings opportunity to structural designers.

When fibers are aligned in only one direction, the resulting structure has maximum strength in that direction, and has little strength in other directions. Therefore, multiple layers or “plies” having fibers aligned in different directions with respect to one another are combined in a desired arrangement to provide combined strength along the principal axis as well as off-axis directions. As such, fibers oriented at 45° degree angles with the principle axis provide strength in two directions. For this reason, the 45° orientation is frequently used in structure that must resist torque. By utilizing permutations of this design philosophy to provide alternate plies of fibers at 0°, 45°, and 90° orientations the structural designer can obtain virtually any combination of tensile, compression, and shear strength in desired directions.

Common forms of fiber used in the production of composite structures include unidirectional tape, unidirectional fabric and bidirectional fabric. Unidirectional tape typically comes pre-impregnated with matrix material and is customarily provided on large rolls which can then be placed in a mold by hand or by robotic tape-laying machines. Similarly, bidirectional fabrics, having fibers running at 0 and 90 degrees, or unidirectional fabrics having fibers running in one direction may also be provided on large rolls pre-impregnated with matrix material. In another form of composite, individual filaments are wound around plugs or mandrels to form desired structural shapes. By way of background, the mandrels duplicate the inner skin of the structure or the inner surface of the structure. This technique is known as filament wound construction.

In addition to the form of fiber used in the production of composite structures, there are a number of fiber and matrix combinations which can be employed to provide desired structural properties of the resulting aircraft components. Fiberglass fiber embedded in an epoxy-resin matrix has been used for years for nonstructural components such as radomes and minor fairings. It is worthy of noting, however, that while fiberglass-epoxy has relatively good strength characteristics, its relatively low strength to weight ratio prevents its use in highly loaded structure. Additional material combinations which have eliminated this condition include: boron fibers used in combination with an epoxy matrix; aramid fibers (known as Kevlar) used in combination with an epoxy matrix, and graphite fibers used in combination with an epoxy matrix.

The United States military has been quick to incorporate fiber composite based structural components in its high-performance military aircraft. For example the F-16 utilizes graphite-epoxy composite material to form the horizontal and vertical tail skins. Similarly, graphite-epoxy composite material is utilized in the F/A-18 where such material forms the wing skins, the horizontal and vertical tail skins, the fuselage dorsal cover, the avionics bay door, the speed brake, and many of the control surfaces. The AV-8B employs composite materials even more extensively. In the AV-8B almost the entire wing, including the skin and substructure, is made of graphite-epoxy composite material with such material comprising approximately 26% of the total aircraft structural weight.

While composite materials have played an important role in reducing the overall structural weight of modern airframes, it should be noted that the basic design and layout of primary load carrying components contained within these structures has remained relatively the same. For example, a conventional aircraft wing structure consists of individual components such as spars, ribs, stringers and skin sections joined in combination to provide an integrated load carrying body which is capable of reacting to aerodynamic forces encountered during flight. As a result, individual spars, ribs, stringers and skin sections are specifically sized and oriented relative to one another so as to provide an optimized structural assembly designed to efficiently carry localized stresses generated by the combined effects of lift, drag, wind gusts, and acceleration loads which interact with surface of the wing or other airframe components.

In order to take advantage of weight savings opportunities afforded by the use of lighter weight materials, individual spars, ribs, stringers and skin sections previously formed from metal alloys have been replaced by similar components formed of fiber composite material. Frequently, these lighter weight components incorporate a “sandwich” style construction having two face sheets, or skins, made of fiber composite material which are bonded to and separated by a core. Typically, sandwich structures are formed with fiberglass-epoxy or graphite-epoxy skins which are bonded with adhesive to a phenolic honeycomb or rigid foam core wherein the skins carry tension and compression loads due to bending and the core carries shear loads as well as the compression loads perpendicular to the skins.

Unfortunately, manufacturing complexity and related labor cost associated with the assembly of numerous individual components, joined together to form an integrated load carrying structure, still remains. For example, conventional airframe construction techniques employ the use of elaborate jig fixtures designed to hold individual component parts in relative alignment during assembly to ensure proper component installation. In addition, drill templates are utilized to locate and drill fastener holes through mating pieces of structure to accommodate bolts or rivets used to mechanically join components together. These construction techniques are time consuming and require a great deal of dimensional precision because an improper installation of structural components may create a weakened resulting structure. Furthermore, the utilization of mechanical fasteners significantly contributes to overall structural weight. It is therefore generally desirable to minimize the number of mechanical joints in a structure in order to minimize both its weight and manufacturing cost while ensuring structural integrity. Integrally formed fiber composites structures have an important advantage over complicated structural assemblies in this respect, since large one-piece components are readily produced.

What has been needed and heretofore unavailable is a one-piece structure which is integrally formed as a unitary body and which is optimized to efficiently carry localized stresses developed from the complex interaction of static and aerodynamic forces encountered during all aspects of aircraft operation. The present invention satisfies these needs.

### SUMMARY OF THE INVENTION

The present invention is directed to integrally stiffened load carrying structures comprising of a plurality of elongated thin-walled triangular tubes placed co-extensively in a complementary side-by-side fashion to form at least a portion of the wall of a hollow core having a desired external contour. Integral skins forming the external and internal surfaces of the core cooperate therewith to provide an integrally formed, unitary load carrying body of “sandwich” style construction.

Upon the application of external forces to the structure, adjacent triangular tubes forming the core cooperate to react loads about the perimeter of the structure. Similarly, adjacent tubes forming an internal support member cooperate to transfer loads from one side of the structure to the other. It will be appreciated that the present invention is capable of providing various load carrying cross-sections. Therefore, the cross-sectional geometry of the load carrying body can be specifically designed to provide a desired external contour which is capable of reacting expected external forces applied thereto.

This structure can be formed by, but is not limited to, extrusion, casting, diffusion bonding, the controlled deposition of material at the atomic level, and filament winding. With regard to the controlled deposition, a controlled deposition method such as Laser-assisted Chemical Vapor Deposition (LCVD) process may be used. Of course, other methods known to one of ordinarily skilled in the art may also be used.

By utilizing well-known filament winding techniques, the material properties of each tube can be specifically tailored to react localized stresses generated from the application of external forces upon the structure. In general, a triangular tube is formed with multiple layers or “plies” of composite material having fibers aligned in different directions. The plies of composite material are arranged with respect to one another to provide a structural element which is capable of reacting to forces in multiple directions. By utilizing alternate plies of fibers oriented at between 0° and 90° orientations relative to the longitudinal axis of the structure, each individual tube will be capable of reacting tensile, compression and shear stress from multiple directions. It will be appreciated that by tailoring the load carry capability of the individual tubes to suit the loads they are expected to encounter, a lightweight, efficient, load carrying structure may be produced.

It is also envisioned that the skins surrounding the internal and external surfaces of the shell and internal support member may be formed with filament wound fiber composite material. Like the construction of the individual triangular tubes discussed above, filament winding techniques may be utilized to tailor the load carrying properties of the skin. By providing layers of composite material having fibers running parallel to the longitudinal axis of the structure, skins suited for carrying localized stresses resulting from the application of longitudinal bending loads may be produced. Likewise, by incorporating layers of composite material having fibers oriented at between 0° and 90° to the longitudinal direction, the skins may also have the ability to react shear stresses resulting from torsional loading of the structure.

In order to design and fabricate integrally stiffened load carrying composite structures embodying the present invention, an estimation of the external forces which will be reacted by the proposed structure must be determined. This estimation requires a thorough understanding of the loading environment and operating conditions that the proposed design is expected to experience. Based upon these expected loading characteristics, the geometry of the proposed design can be used to resolve these forces and moments into resulting localized stresses. Individual structural components can then be appropriately sized and designed to efficiently carry these expected stresses.

Once the localized stresses are known, individual components which form the load carrying structure can be fabricated. The process of building up individual fiber reinforced skins and tubular elements is essentially a three-dimensional strengthening process. By utilizing filament winding techniques, fibers pre-impregnated with matrix material are wound under controlled tension to thereby precisely arrange multiple layers of fiber on a shaped mandrel surface.

From a structural design perspective, the tubular elements cooperating to form the load carrying shell are necessarily required to react stresses generated from more than one direction as resultant forces are applied to the structure from different directions. For example, a wing structure must be designed in such a way to efficiently react lifting forces and associated bending moments, frontal loads associated with aerodynamic drag and impulsive forces associated with wind gusts. Therefore, an important aspect of forming each individual tubular element is to orient the fibers along the mandrels in appropriate directions and proportions to form a composite structure having the desired mechanical properties suitable to carry anticipated localized stresses. While the winding process must produce the desired shape of each tubular element, in the ideal case, fibers will be aligned with the trajectories of principal stresses and will be concentrated in direct proportion to the local magnitude of stress.

After the individual triangular mandrels have been wound with an appropriate combination of fiber, they are placed together side-by-side in a geometrically complimentary fashion about appropriately shaped pre-wound mandrels to form the load carrying structure having a predetermined external contour. Additional fiber is then wound about the exterior of the assembly to provide a skin surrounding the exterior surface of the structure. The assembly is then placed into a mold having mold faces shaped to desired external contour of the structure. For most applications, this process eliminates the need for vacuum bagging and autoclaves. Temperature and pressure are employed by the mold to cure the composite, thereby bonding the skins and triangular tubes together. After the structure has cured, the individual mandrels are removed from the structure to provide an integrally formed, unitary load carrying body.

It will be appreciated that, by way of example and not of limitation, the present invention is capable of providing integrally stiffened aircraft wing structures, rotor blades, fuselage segments and the like, having a reinforced load carrying shell formed integral to an underlying support member such as an X-shaped spar or strut. The skin, reinforced, shell and underlying internal support member thereby cooperate to carry static and aerodynamic forces encountered all aspects of aircraft operation. As a result of this novel method of construction, the need for individual stringers, ribs, spars, and skin sections typically used in combination to form conventional aircraft structures is eliminated.

Other features and advantages of the present invention will become more apparent from the following detailed description of the invention, when taken in conjunction with the accompanying exemplary drawings.

Still another embodiment of the present invention is to provide a strip-tie and a method of making the same to couple to structures together. Moreover, an alternative mandrel may be used to insulate and couple a filament wound tube made from said mandrel. Furthermore, an apparatus and method is disclosed to form a window opening within the fuselage and to install a window covering that is both time saving and cost efficient. Yet another aspect of the present invention is to provide a tie to couple two wing structures together that allows for an operator to inspect the wings. Still further, a plug with a step-tab is disclosed to couple two wing structures together. In another embodiment, a curved plug is disclosed to couple a bulkhead to a fuselage.

### BRIEF DESCRIPTION OF THE DRAWINGS

FIG. 1 is a cross-sectional view of a filament wound load carrying structure in the form of a composite aircraft wing embodying the present invention;

FIG. 2 is a cross-sectional view of a second embodiment of the filament wound load carrying structure of the present invention in the form of an aircraft wing having a predetermined exterior cross-section defined by a load carrying shell which is formed integral to an internal support member;

FIG. 3 is an enlarged cross-sectional view taken from the circle 3 in FIG. 2;

FIG. 4 is an enlarged cross-sectional view taken from the circle 4 in FIG. 3;

FIG. 5 is a perspective view, in enlarged scale, showing a triangular mandrel incorporated in the wing shown in FIG. 1;

FIG. 6 is a perspective view, in enlarged scale, showing a triangular mandrel incorporated in FIG. 1 to provide a composite tube of varying thickness;

FIG. 7 is an enlarged cross-sectional view taken along line 7-7 of FIG. 6;

FIG. 8 is an exploded transverse cross-sectional view of core mandrels incorporated in the wing shown in FIG. 2;

FIG. 9 is a perspective view, in reduced scale, of a core mandrel as shown in FIG. 8 being wound;

FIG. 10 is a perspective view, in reduced scale, similar to FIG. 9;

FIG. 11 is a perspective view of a core mandrel shown in FIG. 9 with fiber wound triangular mandrels placed about the exterior thereof to provide an assembly;

FIG. 12 is a perspective view of the assembly shown in FIG. 11 with the leading edge mandrel added;

FIG. 13 is a perspective view of the assembly shown in FIG. 12 with an exterior skin added;

FIG. 14 is a perspective view of the assembly shown in FIG. 13 placed in an open female mold having a desired external contour;

FIG. 15 is a perspective view of the mold shown in FIG. 14 but in its closed position for application of heat and pressure;

FIG. 16 is a perspective view, partially in section.. similar to FIG. 15 but with the mold open and showing the removal of a mandrel;

FIG. 17 is a perspective view, in enlarged scale, of an aircraft wing shown in FIG. 2;

FIG. 18 is a longitudinal sectional view, in enlarged scale, of the wing shown in FIG. 17 with an end cap attached to the tip end;

FIG. 19 is a fragmented top plan view, of the aircraft wing shown in FIG. 17 wherein plugs are inserted into the structure to facilitate joining components together;

FIG. 20 is a top plan view, partially broken away, of a third embodiment of the filament wound load carrying structure of the present invention in the form of a tapered wing;

FIG. 21A is a plan view, partially broken away, of the wing shown in FIG. 20;

FIG. 21B is an another plain view, partially broken away, with flanges along the root end of the wing shown in FIG. 20;

FIG. 21C is a perspective view of an exemplary plug with a flange on the root end of the plug;

FIG. 21D is a cross-sectional view along 21D-21D along FIG. 21B, with exemplary pins to couple the plugs to the triangular tubes;

FIG. 22 is an enlarged view, taken from circle 22 in FIG. 21;

FIG. 23 is an enlarged cross-sectional view taken along line 23-23 in FIG. 22 with an end cap added;

FIG. 24 is an enlarged perspective view, partially in section, of a triangular tube included in the structure shown in FIG. 20;

FIG. 25 is an enlarged cross-sectional view taken along line 25-25 in FIG. 24;

FIG. 26 is a transverse sectional view of a fourth embodiment of the filament wound load carrying structure of the present invention in the form of an aircraft fuselage structure;

FIG. 27A is a cross-sectional view of a fifth embodiment of the filament wound load carrying structure of the present invention;

FIG. 27B is a side of the fifth embodiment of the filament wound structure of FIG. 27A, illustrating distribution of the load along the structure;

FIG. 28 is a cross-sectional view of a sixth embodiment of the filament wound load carrying structure of the present invention comprising of an aircraft wing formed in sections which fit together with tongue and groove joints;

FIG. 29 is a cross-sectional view of an unfinished blank utilized in making the leading section incorporated in the wing shown in FIG. 28;

FIG. 30 is a cross-sectional view of the finished leading section incorporated in the wing shown in FIG. 28;

FIG. 31 is a cross-sectional view of an unfinished blank utilized in making the trailing section of the wing shown in FIG. 28;

FIG. 32 is a cross-sectional view of the finished, trailing section shown in FIG. 28;

FIG. 33 is a cross-sectional view of a seventh embodiment of the filament wound load carrying structure of the present invention comprising of an aircraft wing formed in sections having coupling joints;

FIG. 34 is a cross-sectional view of tooling blanks utilized to make the wing shown in FIG. 33;

FIG. 35 is a partial exploded cross-sectional view, of the finished wing shown in FIG. 33; and

FIG. 36A is an exploded cross-sectional view of an eighth embodiment of the filament wound load carrying structure of the present invention;

FIG. 36B is an exploded cross-sectional view of an sandwich structure ready to formed into an exemplary flange;

FIG. 36C is an exploded cross-sectional view of an sandwich structure with the base removed;

FIG. 36D is an exploded cross-sectional view of an exemplary flange;

FIG. 37A is an exploded cross-sectional view of an exemplary triangular fibers intermixed within the matrix material;

FIG. 37B is still further exploded cross-sectional view of an exemplary triangular fibers intermixed within the matrix material;

FIG. 38 is a top plan view of yet another embodiment of the filament wound load carrying structure of the present invention in the form of a curved wing;

FIG. 39 is perspective view of a structure being formed from a Laser-assisted Chemical Vapor Deposition process;

FIG. 40 is a perspective view of an exemplary strip-tie for coupling two triangular tubes together;

FIG. 41A is a perspective view of an exemplary filament wound tube;

FIG. 41B is an exemplary press compressing the filament wound tube in accordance with FIG. 41A;

FIG. 41C is an exemplary press in accordance with FIG. 41B in a closed position;

FIG. 41D is an exemplary cross-sectional view of a base for a strip-tie;

FIG. 41E is an exemplary cross-sectional view of a strip-tie;

FIG. 42 is an exemplary exploded view of a leading section and a wing box for an airplane wing;

FIG. 43 is an exemplary enlarged view of an encircled area marked FIG. 43 in FIG. 42 illustrating an exemplary strip-tie being inserted into an opening within a wing box so that a leading section may be coupled to the wing box via the strip-tie;

FIG. 44 is an exemplary cross-sectional view of two tubular composite structures being coupled together using an exemplary strip-tie;

FIG. 45 is an exemplary cross-sectional view of two composite triangle tubes being coupled together using two strip-ties to couple the two structures together;

FIG. 46 is an exemplary exploded perspective view illustrating one method of coupling the front and back fuselage around a wing;

FIG. 47A is an exemplary mandrel in according with one embodiment of the present invention;

FIG. 47B is a cross-sectional view of the mandrel along the line 47B as shown in FIG. 47A;

FIG. 48A is an exemplary view of a flange adapted to couple two structures together;

FIG. 48B is an exemplary cross-sectional view of the flange illustrated in FIG. 48A;

FIG. 48C is another embodiment of a flange configured to couple two structures that are substantially perpendicular to one another;

FIG. 48D is yet another embodiment of a flange used to couple two structures together;

FIG. 48E is still another embodiment of a flange used for coupling two structures together;

FIG. 49A is an exemplary embodiment of a doubler used to strengthen the joint areas between a front fuselage and a back fuselage;

FIG. 49B is an exemplary side view of the doubler as shown in FIG. 49A

FIG. 50 illustrates exemplary supports for strengthening a floor;

FIG. 51 is an exemplary window cut opening in a fuselage;

FIG. 52 is an exemplary exploded view of window frames;

FIG. 53 is an exemplary embodiment of a mandrel used to cut out a window opening;

FIG. 54 is an exemplary cross-sectional view of a pair of railings used to slide a window cover;

FIG. 55 is a front view of the pair of railings as shown in FIG. 54;

FIG. 56 is a front view of an exemplary wing-tie used to couple two wing structures together;

FIG. 57 is an exemplary perspective view of the wing-tie in accordance with FIG. 56;

FIG. 58 is another embodiment of a wing-tie;

FIG. 59 is an exemplary view of wings located on top of a fuselage;

FIG. 60 is an exemplary top view of the wings shown in accordance with FIG. 59, tied together;

FIG. 61 is an exemplary perspective view of a pair of plugs having a step-tab;

FIG. 62 is an exemplary view of a curved plug used to couple a bulkhead to a fuselage;

FIG. 63 is an exemplary view of a bulkhead and a fuselage being coupled together; and

FIG. 64 is an exemplary view of a bulkhead coupled to a fuselage.

### DETAILED DESCRIPTION OF THE PREFERRED EMBODIMENTS

This description is not to be taken in a limiting sense, but is made merely for the purpose of illustrating the general principles of the invention. The section titles and overall organization of the present detailed description are for the purpose of convenience only and are not intended to limit the present invention.

One of the objectives of the present invention is to reduce the weight of a load carrying structure and at the same time reduce the cost of producing the structure. To accomplish the above objective, as in any structural design, the structure may be divided into elements and analyzed by such methods as finite element analysis to determine the load that must be carried by each of the elements. As such, each element may have its own unique load carrying characteristics, that is one element may be subject to more torque stresses than others, while another element may be subject to more tensile stresses. Thus, each element is specifically designed to handle its particular load, so that the combined elements can handle the overall load of the structure. To reduce the weight in constructing the structure, the present invention uses a tubular member with fibers wound in controlled orientation to specifically handle the load for that element. There is reduction is weight because strength to weight ratio of fibers is higher than that of traditional construction materials, such as steel or aluminum. To further optimize the strength to weight ratio of the structure, each layer of fiber is laid in a controlled orientation paralleling the direction of the load, as fibers' strength comes from resisting tensile loads. A further method to optimize the strength to weight of structure is to use specific fiber cross-sections that reduce matrix volume. Accordingly, when the individual triangular members are assembled to form the structure, it can handle the load yet light in weight.

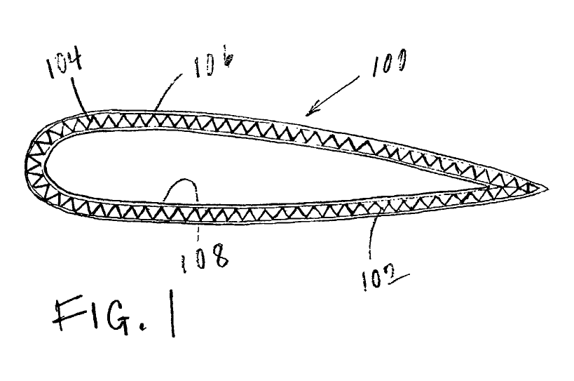

As illustrated by way of example in FIG. 1, the present invention includes an integrally formed composite aircraft wing structure 100 comprising a plurality of elongated thin-walled triangular tubes 102 placed co-extensively in complementary side-by-side fashion to form a body of revolution and bonded together to form a hollow core 104 having a desired external contour. Outer skin 106 and inner skin 108 are bonded to the external and internal surfaces of core 104 and cooperate therewith to provide an integrally formed, unitary load carrying body of “sandwich” style construction.

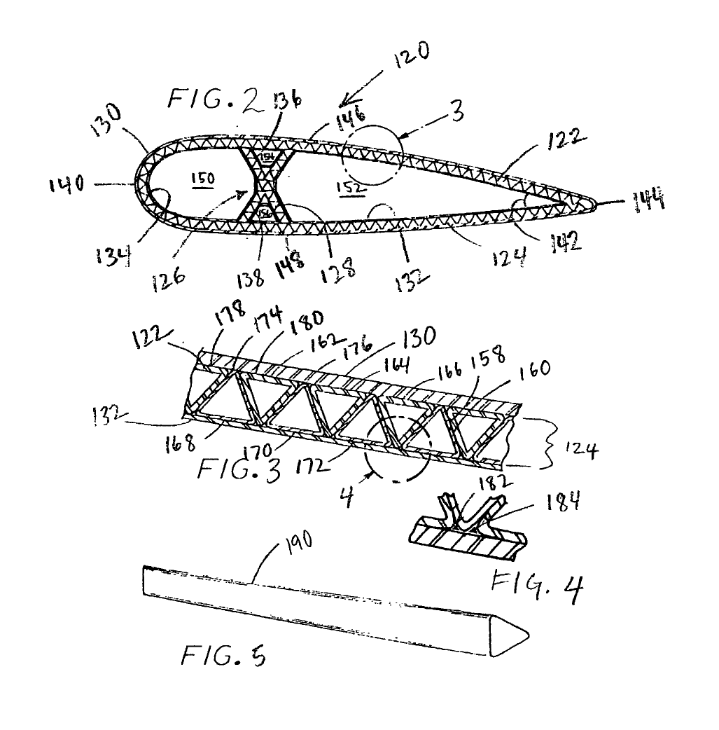

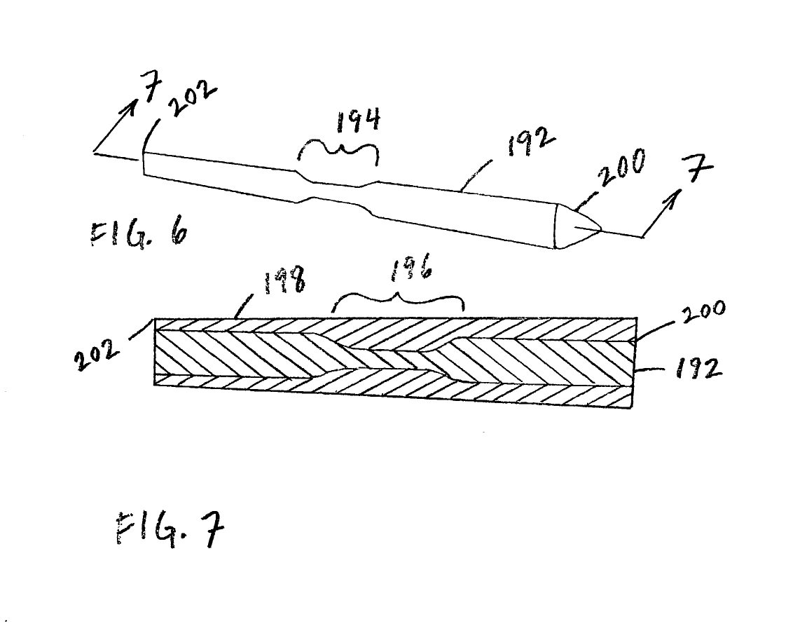

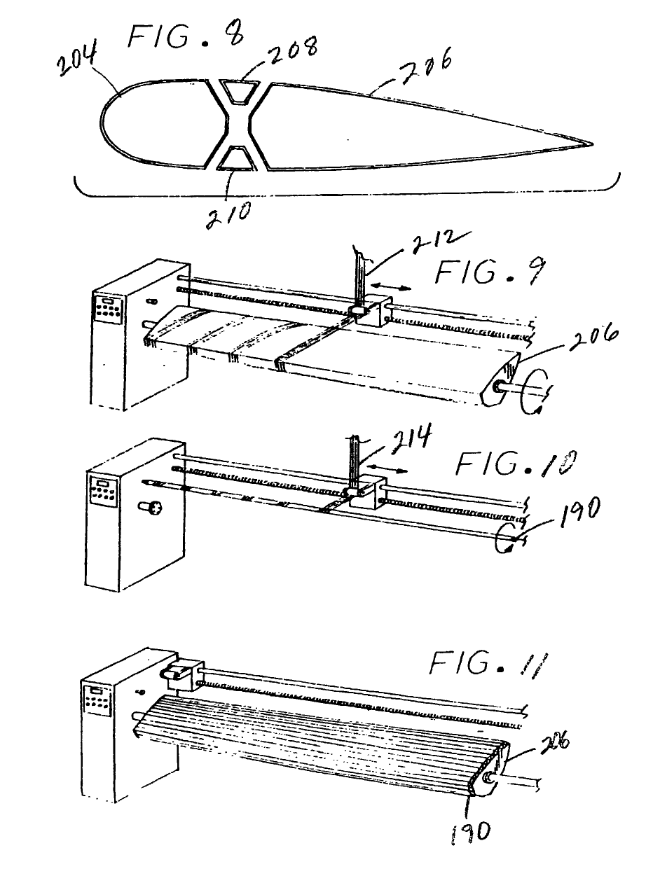

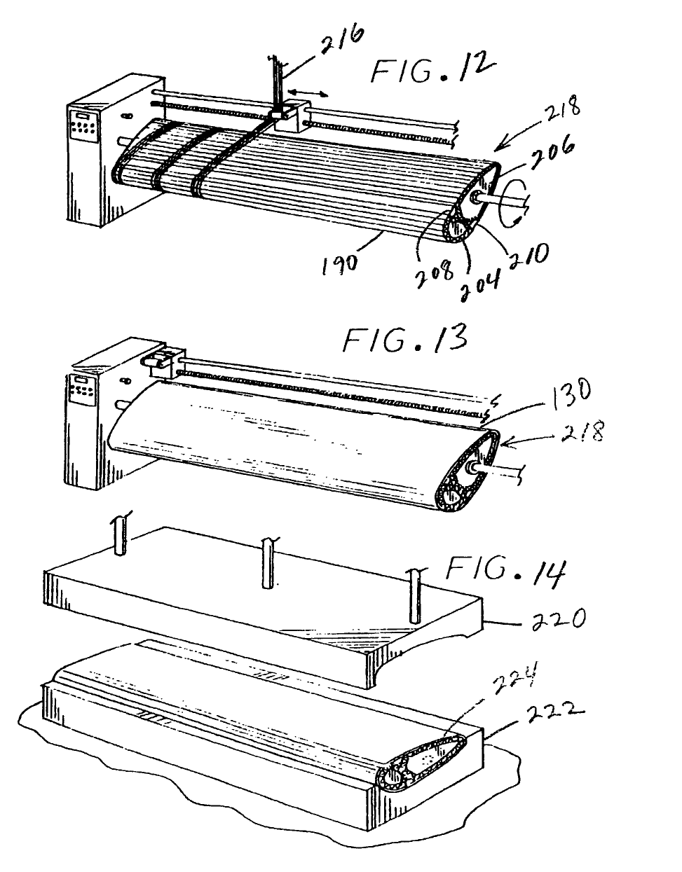

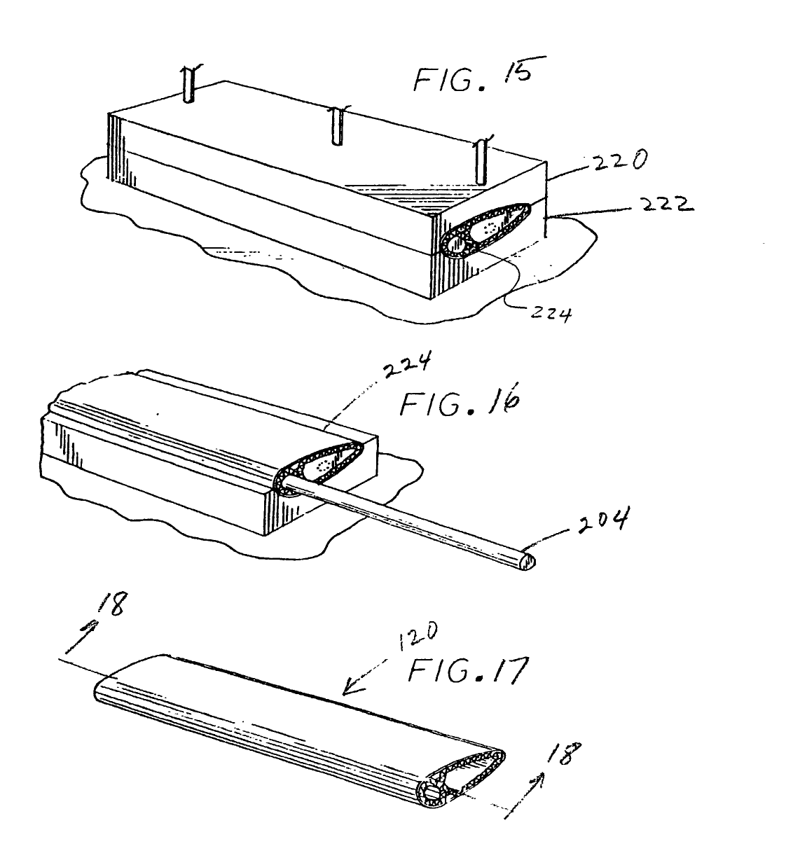

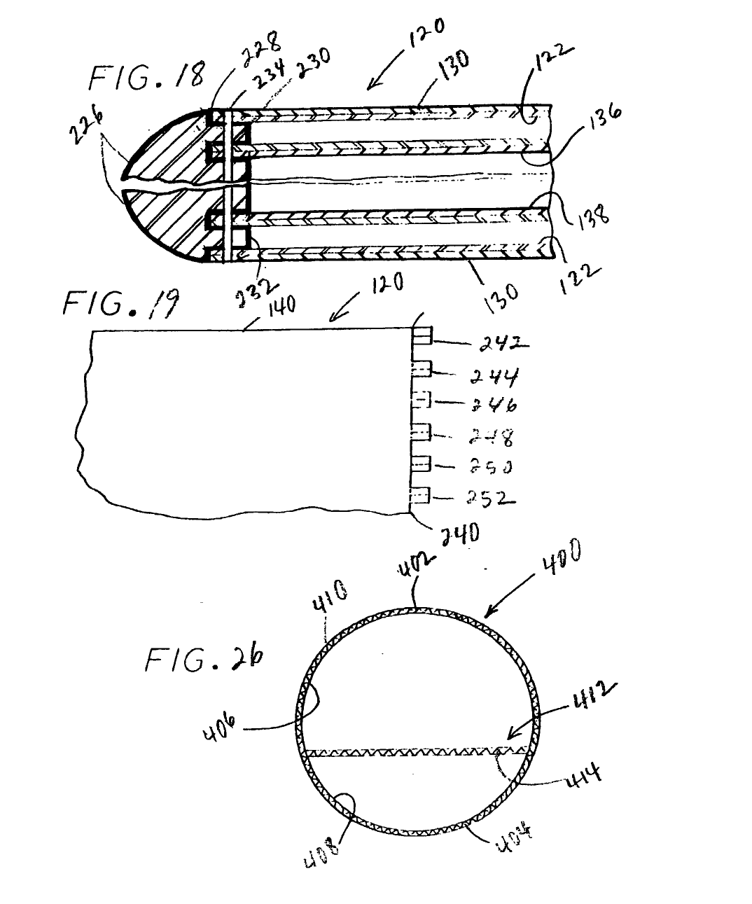

As further illustrated by way of example in FIG. 2, the another embodiment of the present invention includes an integrally formed composite aircraft wing structure 120 comprising of a plurality of elongated thin-walled triangular tubes 122 placed co-extensively in a complimentary side-by-side fashion and bonded together to form a hollow core 124 having a desired external contour. The core 124 is integrally formed with an internal support member 126 having an X shape in transverse cross section and spanning across the hollow interior of the wing structure 120 thereby connecting opposite sides of the shell together. The legs of such support member 126 are formed with a plurality of juxtaposed elongated thin-walled triangular tubes 128 bonded together and arranged to form, for example, a generally X-shaped spar or strut, extending the length of wing, structure 120. Outer skin 130 and inner skins 132, 134, 136, 138 are bonded to the external and internal surfaces of core 124 and cooperate therewith to provide an integrally formed, unitary load carrying body of “sandwich” style construction. In this configuration the core 124, support member 126 and surrounding skins 130, 132, 134, 136, 138 cooperate to provide an integrated load path which extends the length of the wing structure and which is capable of reacting localized tension, compression, and shear stresses resulting from the application of external forces upon the structure.

Referring to FIG. 2, the individual triangular tubes 122 forming the core 124 cooperate to define at least a portion of a body of revolution having a desired curved or compound external contour. As such, the cross-section of wing structure 120 generally forms an airfoil shape having a rounded leading edge 140 which gradually tapers to provide an acute angle 142 terminating at trailing edge 144. The airfoil cross-section also includes upper surface 146 and lower surface 148 which are specifically designed to provide the desired lifting characteristics of the wing structure 120.

Upon the application of external forces to the wing structure, adjacent triangular tubes 122 forming the core 124 cooperate to react loads about the perimeter of the wing structure 120. Similarly, adjacent triangular tubes 128 forming the internal support member 126 cooperate to transfer loads between the upper surface 146 and lower surface 148 of the wing structure 120. For example, the internal support member 126 keeps the upper and lower surfaces 146, 148 from translating relative to each other due to bending moments on the wing structure 120. It will be appreciated that the present invention is capable of providing various load carrying cross-sections. Therefore, the cross-sectional geometry of the load carrying body can be specifically designed to provide a desired external contour which is capable of reacting expected external forces applied thereto. The internal support member 126 extends the length of the structure core 124, wherein adjoining surfaces of the support member cooperate with the interior surface of the shell to define passageways 150, 152, 154, 156 therebetween. The internal support member may be configured to, for example, have generally X-shaped, V-shaped, or W-shaped cross-section to provide an efficient load path between upper surface 146 and lower surface 148. Upon the application of external forces to the wing structure 120, the cross-sectional shape of the support member provides chord-wise shear resistance to core 124. Furthermore, because support member 126 extends the longitudinal length of the shell, shear forces resulting from vertical bending moments are reacted along its length, thereby transferring load between upper surface 146 and lower surface 148.

It will also be appreciated that additional internal support members may be added at various locations along the cross-section. Those skilled in the art will appreciate that the shape, location and number of internal support members will be influenced by the load carrying requirement of the wing structure. Therefore, by altering the cross-sectional geometry of the integrally formed shell and support member, wing structures having different load carrying characteristics can be produced.

In the illustrated embodiment of the present invention the structural core 124, internal support member 126, outer skin 130, and inner skins 132, 134, 136, 138, are constructed entirely from filament wound fiber composite material. As a result, upon co-curing the composite material, these structural elements become bonded together and cooperate to provide an integrally formed one-piece monoque wing structure which is capable of carrying aerodynamic loads encountered during flight.

Referring to FIGS. 2 and 3, the individual triangular tubes 122, 128 forming the load carrying core 124 and internal support member 126 are constructed of filament wound fiber composite material. By utilizing filament winding techniques the material properties of each tube are specifically tailored to react localized stresses generated from the application of external forces upon the structure. In general. each triangular tube is formed with multiple layers or “plies” of composite material having fibers aligned in controlled orientation so that each layer may be laid in different direction than other layers. That is, the plies are arranged with respect to one another to provide a structural element which is capable of reacting forces in multiple directions. By utilizing alternate plies of fibers oriented at 0° to 90° orientations relative to the longitudinal axis of the structure, each individual tube will be capable of reacting tensile, compression and shear stresses from multiple directions. It will be appreciated that by tailoring the load carrying capability of the individual triangular tubes to the loads they are expected to encounter, a lightweight, efficient, load carrying structure is produced.

Referring to FIG. 3, in the illustrated embodiment of the present invention, thin-walled hollow tubes 122 forming the core 124 have triangular cross-sections positioned next to one another in an alternating inverted fashion. While triangular cross-sections are generally preferred for their isometric load carrying properties, other geometric cross-sections may be used. By way of example, and not of limitation, hollow tubes having isosceles triangular, equilateral triangular, or trapezoidal cross-sections may also be utilized.

With continued reference to FIG. 3, the hollow triangular tubes 122 forming core 124 are positioned adjacent to one another in an alternating inverted relationship wherein angled surfaces 158, 160 of adjacent tubes are bonded together. When bonded together, the angled surfaces of adjacent tubes cooperate to provide truss-like load carrying members which connect outer skin 130 and inner skins 132 together.

The bases 162, 164, 166 of alternate ones of the triangular tubes 122 cooperate to define the external surface of core 124. These bases will have a convex shape in cross-section such that they will confirm to a segment of the profile of the airfoil. Similarly, the bases 168, 170, 172 of the respective other alternate ones of the triangular tubes 122 cooperate to define the internal surface of the core 124. These bases will have flat surfaces such that they nest on the longitudinal facets of the inner skin mandrel. It will be appreciated that substantially continuous nature of the external and internal surfaces of the core facilitates bonding surrounding skins to the core. When bonded together, the bases of individual triangular tubes reinforce outer and inner skins, thereby permitting the transfer of localized stresses between the respective skins and the shell.

Because adjacent triangular tubes cooperate with one another and with the surrounding skin to carry loads throughout the structure, the cross-sectional thickness of adjacent tubes may be varied to provide an desired efficient load carrying capability. In an effort to reduce structural weight, the illustrated embodiment incorporates a repetitive pattern of alternative tubes having different cross-sectional thickness. As illustrated in FIG. 3, triangular tubes having thinner cross-sections 174, 176 are disposed between adjacent tubes having thicker cross-sections 178, 180.

Based upon the fundamentals of structural analysis, internal stresses due to bending loads are highest at the cross-sectional extremities of a structure. This stems from the fact that bending stresses within a structural cross-section vary with distance from the neutral axis. As such, cross-sectional locations which are farther from the neutral axis experience higher bending stress than cross-sectional locations at or near the neutral axis.

Referring to FIGS. 2 and 3, in relation to the cross-section of the wing structure 120, the highest bending stresses are carried by the outer skin 130 and adjoining bases of triangular tubes 162, 164, 166. Thus, it will be appreciated that the bases of thicker tubes 178, 180 are joined to the outer skin 130 to provide additional load carrying capability about the cross-sectional extremity of wing structure 120. At locations closer to the neutral axis, bending stresses decrease linearly until becoming zero at the neutral axis. Accordingly, because inner skins 132, 134, 136, 138 are located closer to the neutral axis than outer skin 130, the respective bending stresses carried therein are lower than those carried by the outer skin. Therefore, the cross-sections of inner skins 132, 134, 136, 138 are thinner than the cross-section outer skin 130. In addition, bases 168, 170, 172 of the triangular tubes which are joined to the inner skins have thinner cross-sections than those joined to the outer skin.

The skins 130, 132, 134, 136, 138 surrounding the internal and external surfaces of the shell 124 and internal support member 126 are formed with fiber composite material. Like the construction of the individual triangular tubes discussed above, filament winding techniques are utilized to tailor the load carrying properties of the skin. As such, the skins are formed with multiple layers or “plies” of composite material having fibers aligned in controlled orientation so that each layer may be laid in different directions. The plies are arranged with respect to one another to react forces in multiple directions. For example, by providing layers of composite material having fibers running parallel to the longitudinal axis of the structure, the skins will be capable of carrying localized stresses resulting from the application of vertical bending loads created as lift is produced by the wing. Likewise, by incorporating layers of composite material having fibers oriented at 0° to 90° to the longitudinal direction, the skins will have the ability to react shear stresses resulting from torsional loading of the structure.

Those skilled in the art will appreciate that the composite materials utilized to form the present invention may include, but are not limited to graphite, aramid, boron, or glass fibers embedded in an epoxy matrix. Metallic fibers may also be used in addition to a variety of other polymer or metallic based matrix materials. In general, the fibers function primarily to carry stresses generated in the composite material while the matrix functions to hold the fibers together, distribute the load between the fibers, and protect the fibers from the environment. Therefore, it will be apparent to those skilled in the art that cost, performance, and the material properties of the various material combinations will influence the selection of materials to be used in the design and fabrication of the present invention.

In choosing the appropriate fiber and matrix combination for the present invention, the functional characteristics of both the fiber and the matrix must be considered. For example, in an aircraft where aerodynamic heating is of concern, a matrix material which is suited to withstand elevated temperatures should be selected. Similarly, the load carrying requirements of the structure will greatly influence fiber selection. This is because the relative strength of fibers contained within the matrix determines the load carrying capability of the resulting structure. Therefore, graphite fibers, which have greater load carrying capability, may be utilized in heavily loaded primary structures while weaker fiberglass fibers may be utilized ancillary secondary structures.

To further strengthen the structure, a metal matrix can replace the organic matrix. For example, organic matrix can handle maximum stress level of between 5,000 PSI and 10,000 PSI. On the other hand, titanium aluminide has maximum stress level of about 150,000 PSI; while aluminum has maximum stress levels up to 90,000 PSI depending on the alloy. The fiber material, such as carbon fiber has maximum stress level of about 600,000 PSI to 1,000,000 PSI. Accordingly, with metal matrix, it is an area of strength rather than being a point of weakness like organic matrix.

Another advantage with metal matrix is its high melting temperature. For example, some fighter jets can fly over mach III (about 2,000 MPH), at that speed, the external surfaces of the jet may heat up to 600° F. However, some organic matrix have a plastic temperature of 400° F., i.e., temperature where the matrix is malleable, so that fibers will not hold in its place. On the other hand, aluminum has an approximate melting temperature of 1100° F., with approximate plastic temperature of 600° F. And titanium has an approximate melting temperature of 3,000° F. Accordingly, with metal matrix fighter jet can fly well over mach III without worrying about the metal matrix going plastic.

With regard to applying metal to the fibers, the metal can be plasma sprayed, chemical vapor deposited, or any other method know to one ordinarily skilled in the art. Furthermore, other metals known to one of ordinarily skilled in the art may be deposited onto the fiber. The plated fibers are then wound around the mandrel as discussed above. This can be done in either a vacuum or outside of the vacuum chamber, because of the oxidizing nature of metals such as titanium aluminide. Once the mandrel has been wound with the plated fibers, clamps may be used to hold all the tubes together. Thereafter, heat is applied such that the metal melts, causing the fibers to bond to the adjacent fibers. In other words, matrix material is now metal rather than organic material.

Additional considerations may also be given to non-structural characteristics of the respective materials. For example, metallic or carbon fibers embedded in a polymer matrix are known to have radar absorption characteristics which may be useful in military applications where stealth characteristics are important. Furthermore, because metallic fibers are capable of conducting electricity, they may be utilized to form a composite aircraft structure which has improved resistance to damage from lightning strikes. Likewise, conductive matrix materials may be utilized to provide a similar dissipative effect.

In regard to the radar absorption, the triangular tubes also help absorb and/or redirect the radar signals. That is, as the radar signal enter through one of the sides of the triangular walls, the radar signal than bounces off one of the adjacent wall and keeps bouncing off the three walls; and every time the radar signal hits a surface, a certain amount of energy of the radar signal is absorbed by the triangular tube, until most if not all of the energy of the radar signal is absorbed. With regard to the radar signals that are not absorbed, if any, they will bounce off the triangular tubes tangently and not necessarily deflect back to the radar receiver for detection. Off course, for commercial planes where radar detection is preferred, the plane may be metal plated to deflect the radar signal to the receiver. But for military planes where stealth characteristics is preferred, the combination of the metallic and/or carbon fibers embedded matrix and triangular tubes can absorb much of the radar signals to avoid detection.

It is also envisioned that optical fibers may be incorporated into the composite construction of the present invention to provide an active means for monitoring structural integrity. This is accomplished, for example, by incorporating a continuous length of fiber optic filament within a ply of composite forming a structural component of the wing structure. Light signals passing through the fiber optic filament are then monitored to detect signs of structural damage. When the structure is free from damage, the fiber optic filament remains intact thereby allowing a light signal to pass through its length from a source located at one end of the filament to a detector located at the other end. In the presence of structural damage, however, the fiber optic filament will become severed. As a result, the light signal will be interrupted and the detector will record the loss of the signal.

With regard to the fibers intermixed in the matrix, it will be appreciated that organic matrix material has little load-bearing capability, the material properties of the resulting composite will be limited in proportion to the fractional volume of fiber contained therein. Therefore, higher fiber densities are desired to increase the load carrying capability of the composite material. Conventional fibers, having circular cross-sections, even when tightly packed in relation to one another, leave interstitial spaces which are necessarily filled with matrix material. As a result, the typical composition of fiber composite material comprise of 60% fiber and 40% matrix.

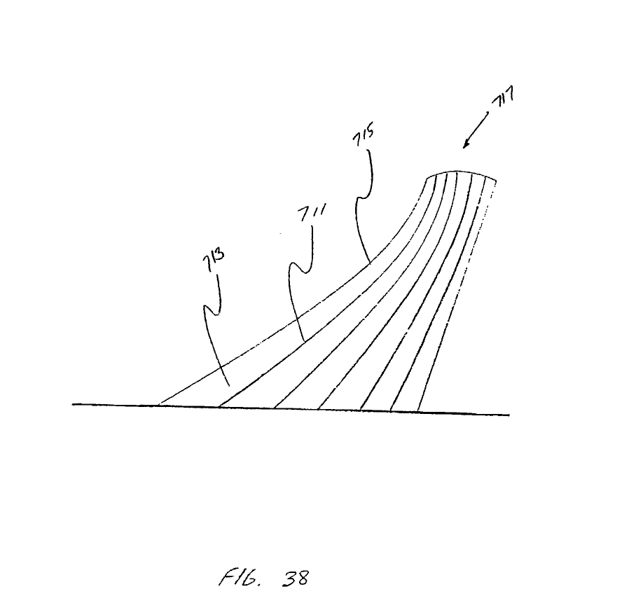

Accordingly, as illustrated by way of example in FIG. 37A, fibers having triangular cross-sections 163 or similar geometric shapes are utilized to improve the content of fibers versus the matrix material 165. As further illustrated in FIG. 37B, the exemplary triangular fibers 163 are placed together in a side by side relationship to minimize the interstitial spaces 165, where gap “g” is the distance between the two adjacent fibers, and “b” is the width of one of the sides of the triangle. As an example, to properly hold the fibers together, the gap “g” may be less than one-tenth (0.1) of width “b” of the fiber. In other words, less than one-tenth of width “b” is filled with matrix material to hold the adjacent fibers together. As a result, according to simple calculation, a combination of fibers and matrix 161 having up to 90% fiber fill and 10% matrix fill may be accomplished. In other words, instead of 60% fiber fill with circular cross-sectional fibers, a 90% fiber fill is possible with triangular cross-sectional fibers, or 30% (90%−60%) increase in strength versus circular fibers. Note that in general, for same cubic volume of fibers and matrix, they both weigh about the same, so there would be a true increase in strength without the increase in weight. This translates into about 30% weight saving in the structure by using the triangular cross-sectional fibers. Of course, the trade off between strength to weight ratio will vary depending on the type of fiber and matrix used.

The placement of triangular fibers in a controlled pattern will be accomplished using microscopic placement of each individual fiber. Alternatively, square or rectangular cross-sectional fibers may also used to increase the fill percentage of the fiber versus the matrix material. For example, the square or rectangular fibers may be microscopically placed like laying bricks with matrix materials in between.

It will also be appreciated that spaces between adjoining load carrying components within a composite structure should be avoided. As shown in FIGS. 3 and 4, spaces created between adjacent triangular tubes 122 forming the core 124 are filled with rods 182, 184. The rods extend the length of the structure and have cross-sectional shapes which compliment the spaces created by the adjoining apexes of adjacent triangular tubes. Preferably the rods may be metallic or formed from material having a load carrying capability which is similar to that of the fibers contained within the adjoining composite. Thus upon co-curing the composite, the rods 182, 184 cooperate with the adjacent tubes and the skin to provide a continuous load bearing structure.

Those skilled in the art will appreciate that the method for constructing a filament wound composite aircraft wing embodying the present invention begins with an initial analysis of a conceptual design bearing the basic geometric configuration of the wing. Before the actual structural members can be sized and analyzed, the loads that the wing will sustain must be determined.

The process of estimating aircraft loads includes a consideration of the combined effects of aerodynamic, structural component interaction, and relative weight distribution of structural components. This analysis is commonly accomplished with the help of finite-element methods in addition to more classical sizing approximations employed by modern structural designers.

The development of expected aircraft loads includes an analysis of typical critical loads experienced during all aspects of aircraft operation. Air loads, for example, are developed from in-flight maneuvering, wind gusts, control deflections, structural component interaction and buffet. Similarly, inertia loads are developed from aircraft acceleration, rotation, vibration, flutter and other dynamic responses to force perturbations encountered during operation. Structural loading is also induced by the power plant wherein thrust, torque, and vibration generate loads which impinge upon associated aircraft structure. Other loads to be considered include those encountered during aircraft taxi, landing, and takeoff. These regions of operation produce localized loads associated with bumps, turns, braking, and vertical accelerations generated from aircraft touchdown. Additional structural accommodations must also be made for less frequent events such as aircraft towing, bird strikes, and jacking associated with maintenance procedures.

Based upon the various external forces which interact with the wing structure, individual components contained therein must be capable of reacting a combination of tension, compression, and shear. For example, a bending force due to a lifting load at the end of the wing produces a combination of tension and compression. The upper surface of the wing structure experiences compression while the lower surface of the wing experiences tension. In addition, torsion produced from a moment which tends to twist the wing produces tangential shear forces in the structure.

Once the design loads for the aircraft wing structure have been developed, individual load carrying components such as the triangular tubes and skin can be appropriately designed and sized to carry the expected load. In general, structural members respond to a load by deforming in some fashion until the structure is pushing back with a force equal to the external load. Once the expected external forces are known, the structural designer can tailor structural geometry and material properties to resolve these forces into the internal localized stresses produced in response to the external load in a manner to provide a lightweight, efficient load carrying structure.

In light of the various forces effecting a wing structure, the creation of appropriately designed and sized structural components becomes an important aspect of the present invention. Therefore, the process of building up individual fiber reinforced triangular tubes 122, 128 and respective skins 130, 132, 134, 136, 138 is essentially a three-dimensional strengthening process. From a structural design perspective, the triangular tubes and surrounding skins, which cooperate to form the load carrying monoque body, are necessarily required to react stresses generated from more than one direction as resultant aerodynamic forces are applied to the aircraft structure during flight. For example, a wing section must be designed in such a way to efficiently react lifting forces and associated bending moments, frontal loads associated with aerodynamic drag and impulsive forces associated with wind gusts. Therefore, an important aspect of forming the triangular tubes and respective skins is to orient the fibers along the mandrels in appropriate directions and proportions to obtain composite material having the desired mechanical properties suitable to carry anticipated localized stresses. While the winding process must produce the desired shape of structural component, in the ideal case, fibers will be aligned with the trajectories of principal stress and will be concentrated in direct proportion to the local magnitude of stress.

Referring to FIG. 5 the fabrication of each load bearing triangular tubes 122, 128 comprise of winding pre-impregnated fibers about an appropriately sized elongated mandrel 190 having a triangular shaped transverse cross-section. The triangular mandrel 190 is constructed of one piece steel or aluminum if withdrawal is possible. For example, mandrel may be withdrawn, when the mandrel is used to form a tapered structure, such as a wing structure, much like withdrawing a knife from its housing. The withdrawable mandrel of course may be reused. Where simple withdrawal is not possible various types of removable mandrels may be employed, including those made of low-melting point metal or soluble plastic. Inflatable and collapsible mandrels may also be used.

As discussed in greater detail below, during the winding process, a continuous length of filament is deposited under controlled tension about the exterior surface of the mandrel 190 to form a layer of composite. The continuous filament is wound about the mandrel 190 in a desired orientation with respect to the longitudinal axis of the mandrel to establish a layer of composite having parallel fibers running in a predetermined direction. As such, a continuous filament is wound circumferentially, longitudinally or helically about the mandrel to deposit complimentary fibers in a side-by-side fashion to provide a layer of composite material having fibers aligned in a desired orientation.

It will be appreciated that by winding a filament circumferentially about the surface of the mandrel 190, a continuous layer of composite material having parallel fibers running at a 90° orientation to the longitudinal axis thereof may be formed. Similarly, a continuous filament that is wound longitudinally about the surface of the mandrel will establish parallel fibers running at a 0° orientation to the longitudinal axis. It will also be appreciated that by winding a continuous filament in a helical pattern about the surface of the mandrel, a layer of composite material having various fiber orientations ranging between 0° and 90° with respect to the longitudinal axis may be formed.

Due to the complex interaction of aerodynamic forces upon the wing structure, individual load carrying tubes must be capable of reacting loads from multiple directions. Therefore, multiple layers of composite material having fibers aligned at various orientations are formed onto the surface of the mandrel to provide a composite cross-section which is capable of reacting to forces from multiple directions. Each individual load bearing tube is formed with a combination of layers which will carry multi-directional tension, compression and shearing stresses. For example, a first layer of fiber material is deposited onto a mandrel by winding a continuous fiber circumferentially about the exterior surface thereof. Thereafter, a second layer of composite material is deposited about the first layer having consecutive fibers running parallel to the longitudinal axis. A third layer, deposited about the second layer, contains fibers aligned at a 30° orientation to the longitudinal axis. Likewise, additional layers of composite having various fiber orientations are applied to form a desired arrangement of composite layers forming the tubular cross-section. The individual plies are then bonded together during the curing process to form a structural entity.

Because the magnitude and direction of the loads throughout the structure vary with location along the wing, the material properties of each triangular tube are specifically designed to accommodate expected localized stresses. Therefore, based upon its location and expected load, each triangular tube is formed with a combination of layers or “plies” of composite material having fibers aligned in predetermined directions to provide material properties suited to carry the expected load. This is accomplished by forming multiple layers of composite material about the surface of the mandrel to provide a composite cross-section having fibers arranged in direct proportion to the magnitude and direction of the expected loads. For example, where high bending loads are expected, triangular tubes are constructed with a greater proportion of layers having fibers running parallel to the longitudinal axis of the mandrel. Similarly, where high torsional loads are expected, triangular tubes are constructed with a greater proportion of layers having fibers oriented at an angle relative to the longitudinal axis.

Based upon the magnitude of expected loads along the longitudinal span of the wing, the cross-sectional thickness of an individual triangular tube may be altered at various locations along its length to provide an efficient load carrying element. In localized areas of highly concentrated loads, a thicker tubular cross-section is formed by winding additional layers of appropriately oriented fibers about the respective mandrel. Similarly, in areas of minimal loading, a thinner composite cross-section is formed with fewer layers of composite wound about the respective region of the mandrel. Therefore, the cross-sectional thickness of each triangular tube is varied along its longitudinal length in direct proportion to the magnitude of the localized loads.

As shown in FIGS. 6 and 7, in order to fabricate a composite tube having regions of greater cross-sectional thickness, the local external dimensions 194 of the respective mandrel 192 are adjusted. Where regions of thicker composite cross-sections are desired, the exterior dimensions of the mandrel 194 are reduced to permit additional layers of fiber composite material 196 to be deposited about the exterior surface of the mandrel. This technique permits the fabrication of thicker cross-sections at certain locations along the longitudinal length of the tube while maintaining a continuous exterior surface 198 of the tube.

In general, vertical lifting forces distributed along the longitudinal span of the wing produce vertical shear and bending moments of increasing magnitude. Due to the cantilevered configuration of a wing structure, the greatest bending loads occur at the wing root. As a result, the cross-sectional thickness of each individual load bearing tube is greater at the wing root end 200 than at the wing tip end 202. The gradual increase in cross-sectional thickness is formed by winding fibers from the root end 200 to the wing tip end 202. Initially, several layers of fiber are deposited along the entire length of the mandrel 192 to establish a smooth and continuous surface. Thereinafter, each additional layer of fiber is terminated prior to reaching the end of the layer below. Thus, a gradual stair-step configuration is created wherein consecutive layers of fiber cooperate to provide a smooth transition from a relatively thin cross-section at the wing tip end 202 to a thicker cross-section at the root end 200.

Referring to FIG. 8, inner skin mandrels 204, 206, 208, 210 establish the general shape and contour of the illustrated embodiment of the present invention. The inner skin mandrels are wound with multiple layers of composite material to form inner skins 132, 134, 136, 138 respectively. In addition, the inner mandrels cooperate with one another to guide the placement and alignment of individual triangular tubes 122, 128 disposed thereabout, thereby forming the core 124. This is accomplished generally in the form of longitudinal facets on surfaces that follow the shape of the airfoil.

Like the triangular mandrels 190 mentioned above (FIG. 5), the inner skin mandrels 204, 206, 208, 210 are constructed integrally of steel or aluminum if withdrawal is possible. Where simple withdrawal is not possible, various types of removable mandrels may be employed, including those made of low-melting point metal or soluble plastic. Inflatable and collapsible mandrels may also be used.

The process for constructing the preferred embodiment of the present invention begins with winding filament about the respective mandrels to form the desired structural components. Referring to FIGS. 9 and 10, an inner skin mandrel 206 is loaded onto a filament winding machine and fibers 212 pre-impregnated with matrix material are applied thereto to form the desired multi-layer composite construction for inner skin 132, having fibers oriented in predetermined directions. This process is repeated for the remaining inner skin mandrels 204, 208, 210, thereby forming the inner skins 134, 136, 138 respectively.

Once the inner skin mandrels have been covered with fiber composite material, individual triangular mandrels 190 are wrapped with fibers 214 pre-impregnated with matrix material to form the triangular tubes 122, 128. As previously mentioned, each triangular tube is formed with multiple layers of composite material having fibers aligned in predetermined directions. By depositing alternate layers of fibers aligned at 0° to 90° orientations relative to the longitudinal axis of the mandrel, each tube will be capable of reacting tensile, compression and shear stress from multiple directions.

As shown in FIGS. 11, 12, and 13, fiber wound triangular mandrels 190 are then positioned in a complementary side-by-side relationship, each triangular mandrel placed in a predetermined position relative to the respective mandrel to handle the load in that position, co-extensive about the wound exterior surfaces of the inner skin mandrels 204, 206, 208, 210 to produce the desired exterior contour as shown in FIG. 12. The mandrels are clamped together to form an assembly 218 (FIG. 12) and fibers 216 pre-impregnated with matrix material are applied to the exterior surface of the assembly to form outer skin 130 disposed thereabout. Again, alternate layers of fibers aligned at 0° to 90° orientations relative to the longitudinal the assembly are deposited about the surface to provide a skin with desired material properties. Since the external skin will carry the greatest loads, it will, in all probability, have the most layers of windings.

As previously mentioned, the skins 130, 132, 134, 136, 138, core 124 and internal support member 126 cooperate to form an integrated load path which extends the length of the wing structure 120 and which is capable of reacting external forces applied thereto. Upon the application of external forces, the individual triangular tubes 122, 128 forming the core and internal support member act as beam elements wherein each tube is subjected to complex loading conditions which may include shear, bending, axial loads, and/or torsion. These combined loads are reacted by the directional fibers contained within the composite cross-section of each tube.

Ideally, loads are reacted by fibers aligned with the direction of the load. As such, fibers aligned with the load direction are placed in uniform tension or compression. It will be appreciated that adjacent triangular tubes are bonded together to form a truss-like network of load carrying structure which is disposed between the exterior and interior skins. Abutting sides of adjacent tubes cooperate to transfer loads from one tube to the next and between the respective skins. Therefore, tension and compression forces contained within the fibers of one triangular tube are transferred and distributed with fibers contained in adjacent triangular tubes. Abutting sides of tubes provide large surface area for bonding which result in reduction in local shear forces between structural elements.

In combination, the skins, core and internal support members provide an integrally formed wing structure which is designed to function as a cantilevered beam. It will be appreciated that the cross-sectional geometry of the wing structure provides a large area moment of inertia which is beneficial to minimizing bending stress created from the interaction of aerodynamic forces therewith. In other words, the loads on the structure are well distributed amongst the skins, core and internal support members, instead of being carried by rivets that hold the traditional aluminum constructed wing structure together, for example.

Referring to FIGS. 14, 15, and 16, the assembly 218 is placed in a clam shell mold having two halves 220, 222 wherein the respective female mold faces have the desired external contour of the final wing structure. The mold is then closed and thereafter the matrix material is cured into a hardened condition by the application of heat, ultrasonic sound, light or pressure, or other methods known to one of ordinarily skilled in the art. Upon the application of heat and pressure to the assembly 218 by the respective mold faces 220, 222, the triangular mandrels 190 and inner skin mandrels 204, 206, 208, 210 contained within the assembly cooperate to apply compressive forces to the composite material disposed therebetween. That is, as heat is applied to the mold with the assembly 218 within the mold, the assembly 218, especially the matrix, expands at a higher rate than the mold, so the assembly 218 will pressurize itself. The compressive forces applied to the composite material act to remove air trapped between layers of composite and ensures that adjoining matrix material properly bonds together. Therefore, in most applications, the utilization of a clam shell mold eliminates the need for vacuum bagging and autoclaves.

In particular, with ultrasonic sound, it can cause the matrix material vibrates and heats up thereby bonding the adjacent tubes together. With ultrasonic light, it can cause certain epoxies to vibrate, which heats up the epoxies to bond the adjacent tubes together.

Furthermore, before curing the matrix, colored gel may be applied to the outer layer to add color, to eliminate the need for painting the outer surfaces of the wing structure after it has been removed from the mold. Still further, aluminum outer skin may be applied to the outer layer of the assembly 218, then cured to provide additional strength to resist the loads, protection against lightning strikes, and to deflect back radar signals, if desired.

Those skilled in the art will appreciate that the curing of the matrix bonds adjacent triangular tubes and respective interior and exterior skins together to form an integral, monoque body. After the matrix has cured to a hardened condition, the mold halves 220, 222 are separated and the formed article 224 can be removed. Core mandrels 204, 206, 208, 210 and triangular mandrels 190 are then withdrawn from the structure thereby leaving hollow passageways extending therethrough.

If the mandrel cannot be withdrawn, other methods may be used. For example, a mandrel may be formed with a material having a melting temperature of 200° F.; and use a matrix material that has a curing temperature of 150° F., however, once the matrix is cured, it may have a plastic temperature of 400° F., i.e., temperature where the matrix is malleable. Accordingly, the mold along with the assembly 218 may be heated between 150° F. to 200° F., to cure the matrix, and once the matrix has solidified, the assembly may be once again heated between 200° F. to 400° F. to melt the mandrel so that it will flow out to leave the wing structure 120. Yet another method is to dissolve the mandrel out. For example, acid may be poured into the assembly 218, where the mandrel is designed to react with the acid but the wing structure is not, so the acid would dissolve the mandrels and leaving the wing structure intact. Alternatively, any other methods of removing the mandrel know to one of ordinarily skilled in the art is within the scope of the present invention.

It will be appreciated that the hollow passageways formed into the structure once the mandrels are removed provide areas where high pressure hydraulic lines, control cables, electrical lines, and the like, may be routed. In addition, the hollow triangular tube forming the shell may be filled with heated air diverted from the power plant (engine) to facilitate de-icing of the wing.

Furthermore, tiny holes drilled through the exterior skin and into the triangular tubes forming the shell to provide suction pipes which may be utilized to control laminar air flow over the wing, to minimize turbulence from occurring thereby reducing the drag on the wings. By way of background, as air flows over the wing, air remains laminar for about the first one third (⅓) of the cross-section of the wing, i.e., air flows smoothly across this cross section of the wing forming a boundary layer. However, as the air flows further along the chord of the wing, it slows down due to friction. This results in turbulence, which means that air is no longer smoothly flowing across the wing such that the boundary layer is running off of the wing. This results in higher drag. To minimize the turbulence, holes may be drilled to suck in the turbulent air through the triangular tubes so that the boundary layer is pulled back down, to allow the air to smoothly flow across the tail end of the wing. Additional holes may be placed further along the chord of the wing to maintain the boundary layer closer to the wing thereby maintaining the laminar flow. As a result, the aerodynamic drag is reduced to minimize fuel consumption.

The hollow passageways also provide a means of access to interior portions of the structure. Therefore, the passageways may be utilized to facilitate routine inspection of the structure using non-destructive methods of testing including ultrasonic, magnetic and laser technologies. In addition, the large hollow areas formed into the structure after the core mandrels have been withdrawn may be utilized as internal fuel tanks.

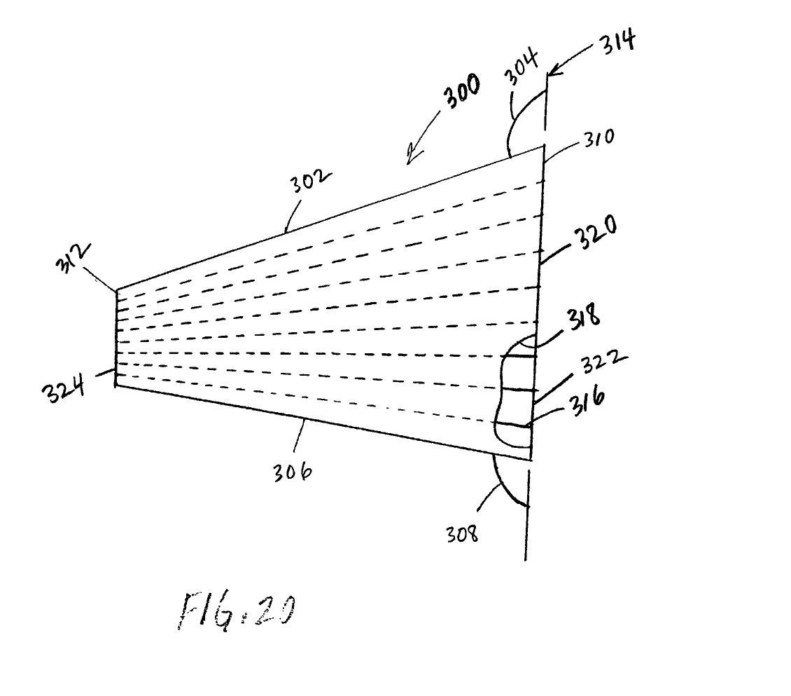

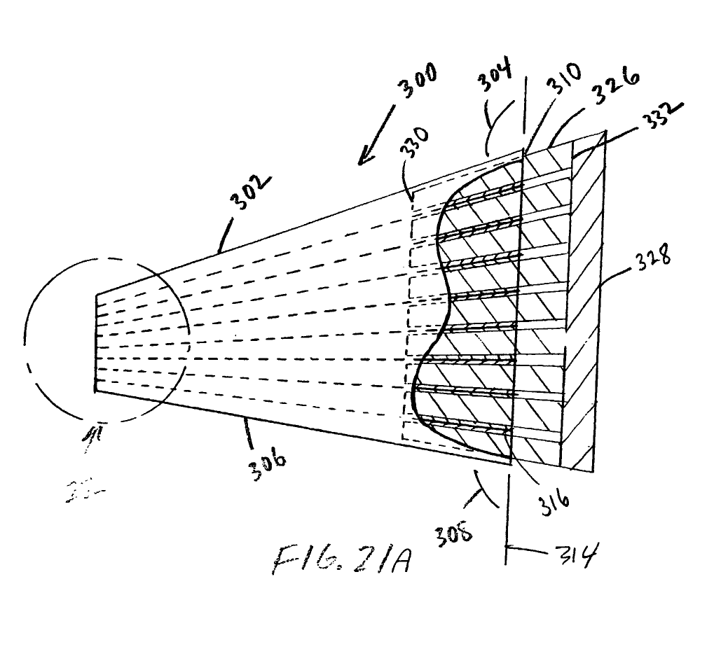

As illustrated in FIG. 18 a molded fairing 226 may be attached to the wing tip end 228 of the wing structure 120 to provide an aerodynamic wing tip and prevent the tip from delaminating. The fibers on the tip of the wing may delaminate because after the mandrel has been wound, there may be excessive ends which may need to be cut off. Accordingly, ends may be exposed to the atmosphere, such as wind forces, and therefore etch away the matrix material to expose the fibers. To protect from delamination, the fairing 226 may be used to overlap the tip. To facilitate joining the fairing 226 to the adjacent composite wing structure 120, the fairing is formed with a series of plugs 230, 232 which are arranged in a pattern to fit inside the respective hollow triangular tubes 122 and respective channels 150, 152, 154, 156 (FIG. 2) created by the inner skin mandrels. Holes drilled through the wing structure and into the plugs 230, 232 allow pins 234 (FIG. 18) or other fastening devices to mechanically fasten the parts together.

While the fabrication of an entire wing structure as described in the present invention minimizes the number of joints in a structure thereby reducing both the weight and cost of the resulting airframe, mechanical joints are required to transmit loads between the composite wing structure and adjoining portions of the airframe. For example, two wing halves may be joined together or a wing half may be mated to a corresponding fuselage section.

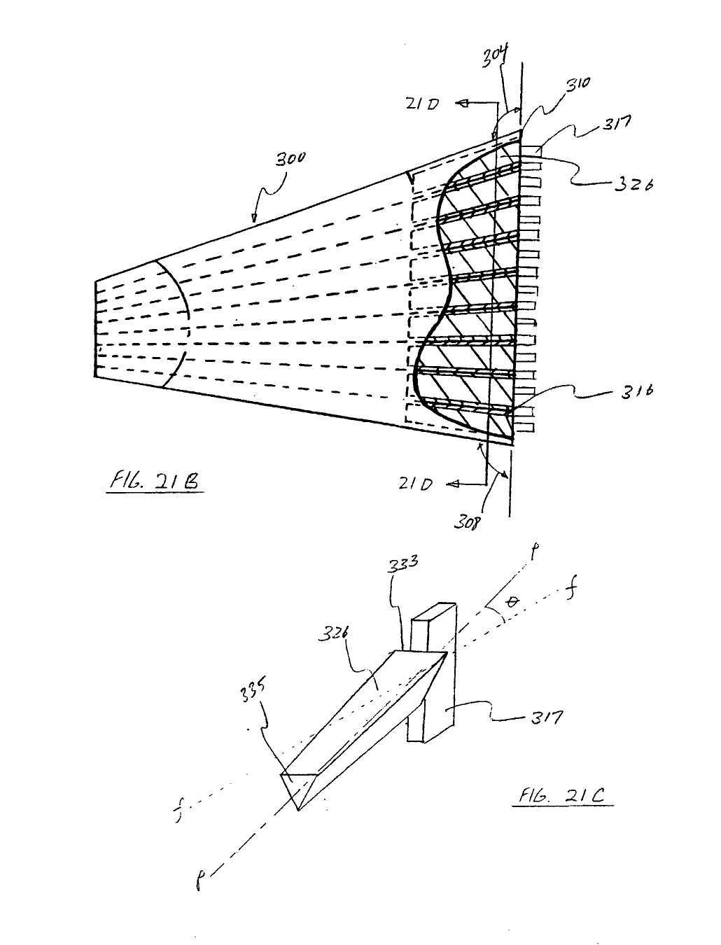

As illustrated in FIG. 19, load bearing plugs, 242, 244, 246, 248, 250, 252 are mechanically fastened to the root 240 of the wing structure 120 and an adjoining fuselage segment to facilitate the transfer of loads therebetween. The plugs have a cross-section identical to the inner surface of the tubes 122 to fit inside the hollow triangular tubes 122 forming the load carrying core of the wing structure where mechanical fasteners are used to connect the parts together. It is envisioned that the load bearing plugs may be formed with metallic or polymer based materials. Unfortunately, graphite-epoxy materials are electrically conducting and cathodic with respect to most metals. Thus, to avoid the danger of galvanic corrosion of the metal side of a joint, special precautions are required.

In general, fasteners and metallic plugs made from aluminum alloys or steel should be avoided unless they can be insulated from graphite-epoxy composite. The preferred fastener material, particularly for bolts and lock pins, is titanium alloy, although stainless steel is also considered to be suitable.

While the wing structure described above was illustrated as having a constant chord, swept wings having a desired taper ratio are also envisioned in the present invention. As shown in FIG. 20, wing structure 300 includes a leading edge 302 having a desired sweep angle 304, a trailing edge 306 having a desire sweep angle 308 with respect to the fuselage plane 314. In this embodiment, the respective sweep angles 304, 308 of the leading edge and the trailing edge 302, 306 cooperate to provide a generally trapezoidal shape platform. As a result, the chord located at the wing root 310 is larger than the chord located at the wing tip 312, thereby defining a desired taper ratio.

Like the previous embodiment, wing structure 300 includes a plurality of elongated thin-walled triangular tubes 316 placed co-extensively in a complementary side-by-side fashion which are bonded together to form a hollow core 320 having a desired external contour. As shown in FIG. 20, the triangular tubes 316 taper in laterally from the root end 322 to the wing tip end 324. Therefore, adjacent tubes cooperate to provide the desired taper ratio defining leading edge sweep angle 304 and trailing edge sweep angle 308. Note that for a swept wing, the angle 308 can be less than 90°. Outer skin 318 is bonded to the external surface of the core 320, and an inner skin (not shown) is bonded to the interior surface of the core. Similar to the previous embodiment, the core 320 and the respective inner and outer skins cooperate to provide an integrally formed monoque load carrying body of “sandwich” style construction. Likewise, if structurally required, the core 320 may be integrally formed with an underlying internal support member as shown in FIG. 2.

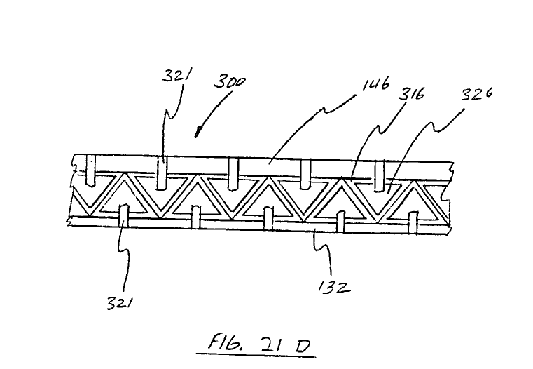

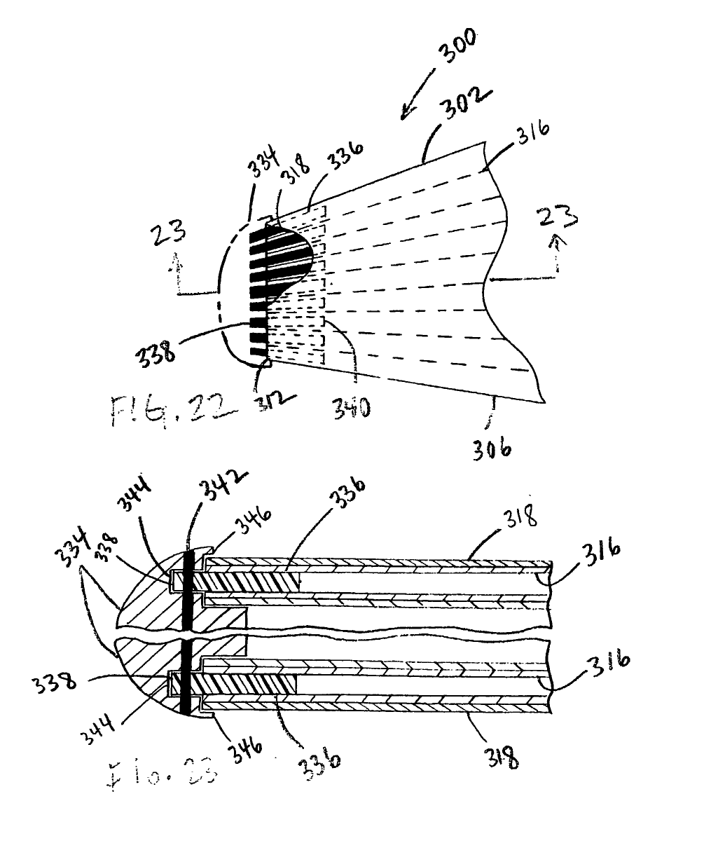

As illustrated in FIG. 21A, load bearing plugs 326 can be bonded to the root 310 of the wing structure 300 to facilitate the joining and transfer of loads between the wing and corresponding fuselage structure. The plugs 326 are generally triangular in transverse cross section having an outer end 330 and inner end 332. The outer end 330 of each plug 326 fits inside the root end of a hollow triangular tube 316 forming the load carrying shell where mechanical fasteners or adhesives are used to connect the parts together. Due to the tapered configuration of each triangular tube 316, the individual plugs 326 are formed with a complementary lateral taper allowing them to be slidably inserted into their corresponding hollow tubes. As such, the lateral taper and cross sectional dimensions of the plugs are designed to permit each plug to be inserted a desired distance inside its corresponding tube. When properly installed, the plugs 326 fit securely inside the tubes 316 wherein the external surfaces of the plugs contact the interior surfaces of the tubes. A load bearing frame 328 is mechanically fastened to the outer end 332 of the plugs thereby connecting adjacent plugs together. Alternately, the plugs may be directly connected to each other such that frame 328 is surplus.

It will be appreciated that for highly tapered wing structures, the corresponding lateral taper of the individual triangular tubes contained therein increases. As a result, the angle of insertion and direction of travel of each plug differs for each hollow tube forming the shell 320. Therefore, once the plugs are inserted into their respective tubes and joined together as an assembly by the frame 328, simple withdrawal of the plugs becomes geometrically impossible. Thus mechanical fasteners or adhesives used to connect the outer ends 330 of the plug to the wing structure may be eliminated.

Alternatively, as illustrated by way of example in FIGS. 21B-21D, each of the plugs 326 may be adapted with a flange 317, in order to couple the wing structure 300 to the fuselage, which has been adapted to receive the flanges. To do so, as best shown in FIG. 21B, each of the respective flanges 317 have a longitudinal axis that is parallel to each other. As shown in FIG. 21C, to have parallel axes, each of the flanges are formed on the root end of it respective plugs at an angle θ between the plug and flange longitudinal axes p-p and f-f, respectively. In general, the longitudinal axis of flange f-f is perpendicular to the longitudinal axis of the fuselage. Accordingly, the plug for the triangular tube closest to the leading edge 302 would have an angle θ for the flange that is about the sweep angel 304 minus 90°. Of course, the angle θ will vary from flanges located near the leading edge 302 to flanges located near the trailing edge 306, so that all of the flanges are aligned. Also note that the plug 326 has a larger cross section along the root end 333 than the tip end 335, to match the corresponding tapered triangular tubes.

With regard to installing the plugs in the triangular tubs, as an example, if there are 100 triangular tubes running across the upper surface and another 100 triangular tubes running across the lower surface of the wing structure, up to 200 plugs with respective flanges may be fitted into all 200 triangular tubes. Of course, depending on the load along the root of the wing structure not all of the triangular tubes needs to have a plug with a flange. Once all of the necessary plugs are inserted into the corresponding triangular tubes such that all of the flanges align nested to each other; the flanges can be coupled together by a variety of means. For example, the adjacent flanges can be bolted together, bonded, and/or an elongated pin may be used to run through all of the flanges to couple all of the flanges together. Or any other methods know to one of ordinarily skilled in the art. Note that before the flanges are coupled, the individual plugs can be withdrawn from the respective triangular tubes; however, once the flanges are coupled together, the none of the plugs can be withdrawn as discussed above. Therefore, plugs are held within the triangular tubes even without such securing means as bolts and/or being bonded.

However, securing means as discussed above may be used to hold the plugs within the triangular tubes. For example, as illustrated by way of example in FIG. 21D, pins 321 may be used to further hold the plugs in respective triangular tubes. As further illustrated in FIG. 21D, the pins may be alternated across the upper and lower surfaces so that the pins penetrate through the base of the triangular wall rather than the tip where stresses tend to be high.

Once the flanges are coupled together, the wing structure can be coupled to the fuselage which is adapted to receive the coupled flanges. Alternatively, in situations where the wings are coupled to each other, the flanges can be used as the intermediary structure to coupled the two wings together. Note in cases where the wing gets damage, the flanges can be undone to remove the damaged wing, and replaced with a new wing. So that time for fixing a damage wing and the down time for the aircraft is significantly reduced.

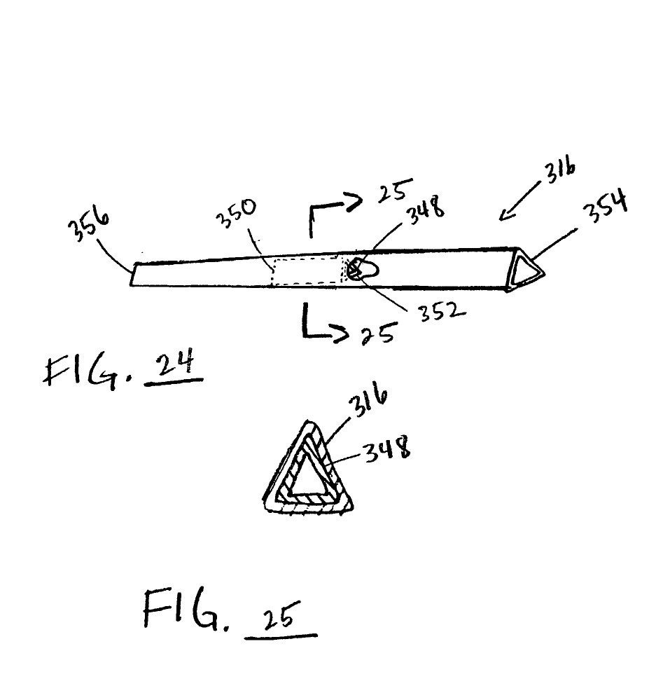

Referring to FIGS. 22 and 23, a molded fairing 334 may be attached to the wing tip end 312 of the wing structure 300 to provide an aerodynamic wingtip. To facilitate the installation of the fairing 334, a series of end plugs 336 are installed in the triangular tubes 316 forming the shell 320. The end plugs 336 are generally triangular in transverse cross-section having an outer end 338 and an inner end 340. Due to the tapered configuration of each triangular tube 316, individual end plugs 336 are formed with a complementary lateral taper allowing them to be slidably inserted into their corresponding hollow tubes. As such, the lateral taper and cross-sectional dimensions of the end plug are designed to permit the outer end 338 to be inserted in the root end of a corresponding hollow tube. The end plugs 336 are then advanced within the hollow tubes until a desired portion of the outer ends extend beyond the wing tip end of the tube 312. It will be appreciated that the lateral taper and cross sectional dimensions of the end cap are designed to permit the outer end of each plug to advance a desired distance beyond the wing tip of the tube wherein the inner end of each plug 340 is retained within the corresponding hollow tube. When properly installed, the retained portion of each end plug fits securely inside the corresponding tube wherein the external surfaces of the cap contact the interior surfaces of the tube.

Referring to FIG. 23, the molded fairing 334 can be formed with a series of receptacles 344 which are arranged in a pattern to receive the exposed portions of the end caps extending beyond the wing tip end 312 of the triangular tubes 316. Holes drilled through the fairing 334 and into the end plugs 336 allow pins 342 or other fastening devices to mechanically fasten the parts together. Alternatively, the molded fairing may be a shell (not shown) to enclose the wing tip end 312 with a hole drilled through the shell so that it can be pined to the wing tip. Additionally, the molded fairing may be adhered to the wing tip end.

The molded fairing also includes a retaining flange 346 disposed about the perimeter of the fairing which projects longitudinally. The flange 346 is configured such that upon the installation of the fairing, the inner surface of the flange overlaps the outer skin 318 of the wing structure thereby protecting the wing tip end 312 of the wing structure 300 from exposure to the environment and prevent delamination.

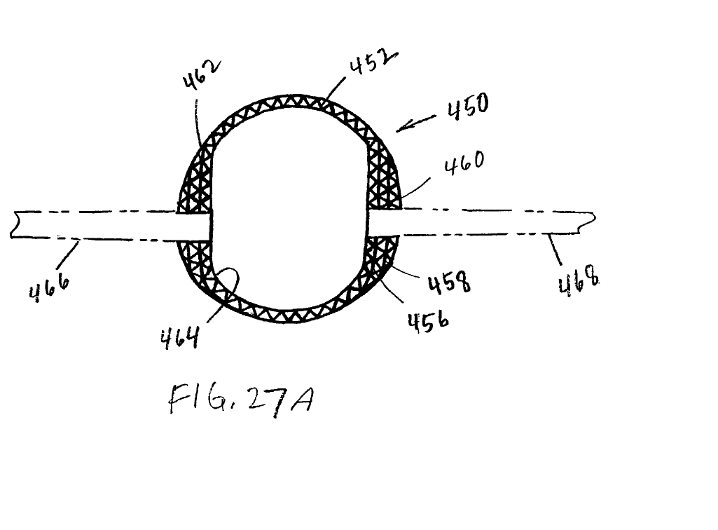

As discussed above, end plugs 336 and plugs 326 are slidably inserted into the hollow triangular tubes forming the core 320 to provide a means for joining structural components to the respective ends of the wing structure 300. Referring to FIG. 24, in a similar fashion, structural inserts 348 are positioned within the hollow triangular tubes 312 to provide structural reinforcement for local areas of the wing structure where hardware may be attached. As illustrated, in FIGS. 24 and 25, a triangular insert 348 having an outer end 350 and an aft end 352 is positioned within the hollow interior of a triangular tube 316. The outer end 350 of the insert 348 fits inside the root end 354 of the hollow triangular tube. The insert is then advanced along the interior of the tube to the desired location. Where the triangular tube 316 is formed with a lateral taper, the insert is formed with a complementary taper. As such, the lateral taper and cross sectional dimensions of the insert are designed to permit the insert to be advanced a desired distance within the triangular tube 316. The insert is designed such that when it is advanced to a desired location along the length of the tube the insert fits securely inside the tube wherein the external surfaces of the insert contact the interior surfaces of the tube. Holes are then drilled through the composite structure and into the insert to facilitate the attachment of hardware to the structure. These plugs can also be used to repair and/or reinforce areas of the structure that have been damaged.

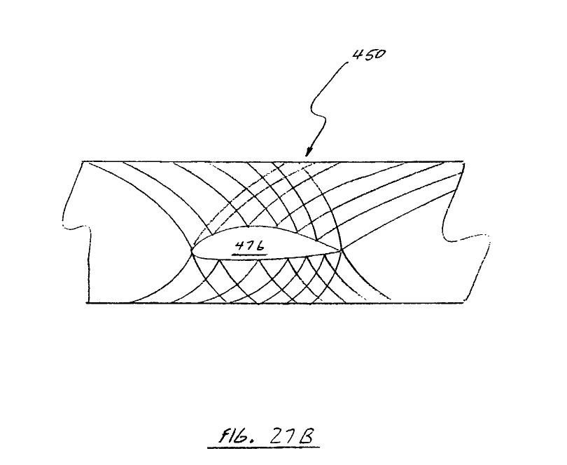

As shown in FIG. 26, an alternate embodiment of the load bearing structure of the present invention is in the form of an integrally formed composite fuselage structure 400 including a plurality of elongated thin-walled filament wound triangular tubes 402 placed co-extensively in a complementary side-by-side fashion and bonded together to from a hollow circularly shaped core 404 having a desired circular cross-section. Cross-sections of oval, square, rectangular or trapezoidal are also possible. Skins 406, 408, 410 bonded to the external and internal surfaces of the core cooperate therewith to provide an integrally formed, unitary load carrying body of “sandwich” style construction. The shell is integrally formed with an internal support member 412 spanning across the hollow interior of the fuselage structure thereby connecting opposite sides of the shell together. The support member 412 is formed with a plurality of elongated thin-walled filament wound triangular tubes 414 bonded together in a complementary side-by-side fashion to provide, for example, a ceiling or floor panel extending the length of the fuselage structure.

It will be appreciated that, in practice, while the core 404 may not make a classic smooth circle on its inner surface, it will often tend to have the generally circular configuration. In any event, the filament wound tubes 402 will be abutted side by side and having longitudinal, centrifugal and helical windings will generally cooperate to efficiently resist forces in a multitude of directions. The composite wall will also resist radially inwardly acting forces, such as might be encountered by wind forces acting radially inwardly. That is, the load generated by such inwardly acting forces will generally apply a compressive load across the cross section of such tube so that the walls thereof are generally placed in compressive load in the transverse plane. Also, it will resist outward forces generated by pressurization. Also, as different loads are applied longitudinally along the body of the fuselage resulting in various torque loads being applied to the tubular structure defining such fuselage, the efficient, integral, circularly shaped composite wall will result in the filament wound tubes cooperating together as a composite hollow circular beam to efficiently resist such bending forces.

Furthermore, the triangular tubes running longitudinally along the axis of the fuselage may have constant cross-section throughout, i.e., not tapered, because the load along the longitudinal axis is similar. In such a case, withdrawing the mandrel from the triangular tubes may be more difficult than if it was tapered. Here, however, rather than removing the mandrel, it may be left in the triangular tubes to serve as an insulating material to keep the internal temperature warm, especially in high altitudes where temperature can be below −50° F.; and serve as a sound deadening insulator to keep the engine noise out. In this case, the mandrel may be made of strong lightweight foam. Furthermore, the mandrel left in the triangular tubes also adds stiffness to the tubes such that the mandrel help resist the loads on the tubes. Thus, leaving the mandrel in the tubes eliminates the need to install additional insulation layers, which saves weight and lower the cost of producing the plane. Of course, mandrels in some of the triangular tubes may be removed to serve as a duct to pump oxygen, heated air, or cables therethrough, among other things.

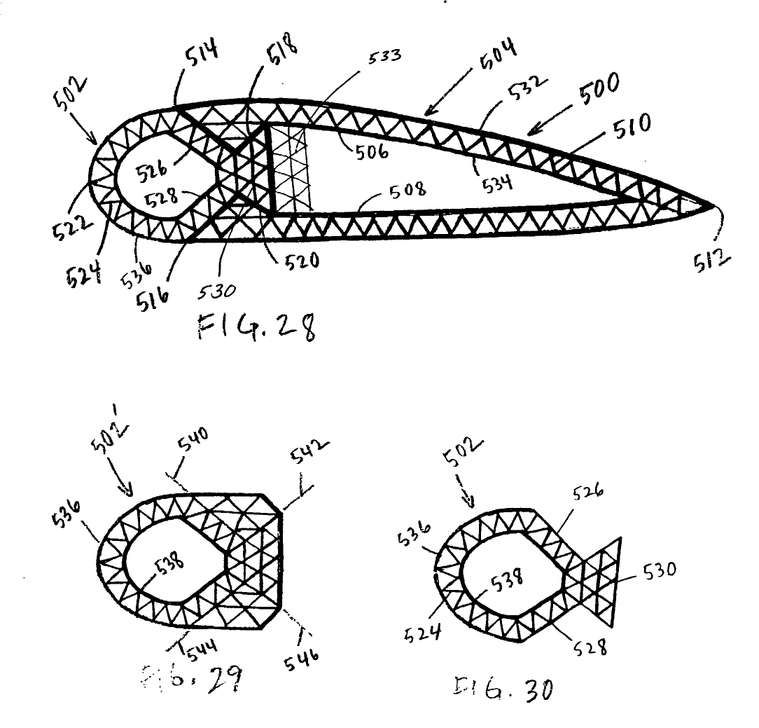

In another embodiment as shown in FIG. 27A, an integrally formed fuselage structure 450 includes a plurality of elongated filament wound triangular tubes 452 placed co-extensively in a complementary side-by-side fashion and bonded together to form a hollow core 454 having a desired circular cross-section. Outer skin 462 and inner skin 464 are bonded to the external and internal surfaces of the core and cooperate therewith to provide an integrally formed, unitary load carrying body of “sandwich” style construction.

It will be appreciated that in highly loaded areas of the fuselage structure, the triangular tubes forming the core 454 may be arranged in a manner to provide increased load carrying capability. As shown in FIG. 27A, in lightly loaded areas of the fuselage structure, such as top section 466 and bottom section 468, the core 454 is formed with a single row of triangular tubes positioned in an alternating inverted pattern. In highly loaded areas of the structure, such as along side sections 470, 472 which are joined to wing halves 474, 476, additional rows 458, 460 of triangular tubes 452 are added to increase the localized load carrying capability of the structure. This eliminates the need for wing carry-through structure (or center section).

Furthermore, as illustrated by way of example in FIG. 27B, in addition to the rows 458, 460, the fuselage would be wound in a controlled orientation to distribute the load throughout the fuselage the load being transferred from the wing. That is, the load from the wing is distributed in a wide area of the fuselage to prevent longitudinal buckling of the fuselage.

Referring to FIG. 28, the embodiment of the filament wound load bearing structure shown therein is also in the form of a wing 500 formed with a leading section 502 and trailing section 504 The trailing section 504 is configured with top and bottom walls 506 and 508, respectively, constructed of filament wound triangular tubes 510 and arranged so that such top and bottom walls diverge forwardly from a trailing edge 512 to terminate in respective forward ends 514 and 516. Mounted on the inside of the respective top and bottom walls are respective longitudinally projecting triangular filament wound tubes which cooperate to form coupling lugs 518, 520. The leading section 502 is formed with a rounded forwarded wall defining a leading edge 522 and is constructed with the filament wound triangular tubes 524 to define such wall so that the top and bottom walls thereof project rearwardly and formed with rearward sections 526 and 528 which converge inwardly and are formed at their rear portion with a dovetail shaped keeper, generally designated 530, which is configured to slidably engage behind the respective coupling lugs 518 and 520. The tubes 510 and 524 are wound with longitudinal, circumferential and helical winds to optimize the resolution of stresses.

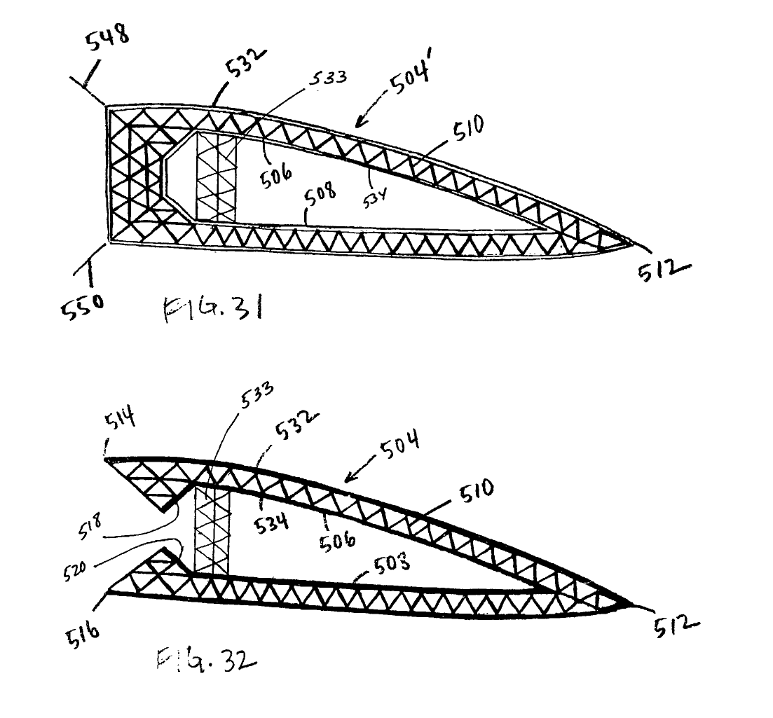

Referring to FIGS. 29 and 30, the leading section 502 may be formed around a removable mandrel wherein the triangular tubes 524 are arranged to define a tooling blank 502′ in the configuration shown to define an assembly having an outer skin 536 and an inner skin 538 attached thereto (FIG. 29). The blank 502′ is constructed at its back wall with multiple layers of tubes 524 so that selected ones thereof may be removed to form the tongue 530. The assembly is then cured to form an integral unitary body. The desired final shape of the leading section 502 (FIG. 30) is obtained by machining away selected outer layers of tube structure defined by the intersection of cutting planes 540, 542 and 544, 546. Thereafter, the remaining structure includes a rounded leading wall defining leading edge 522, the inwardly converging segments 526 and 528 and the keeper tongue 530 (FIG. 30).

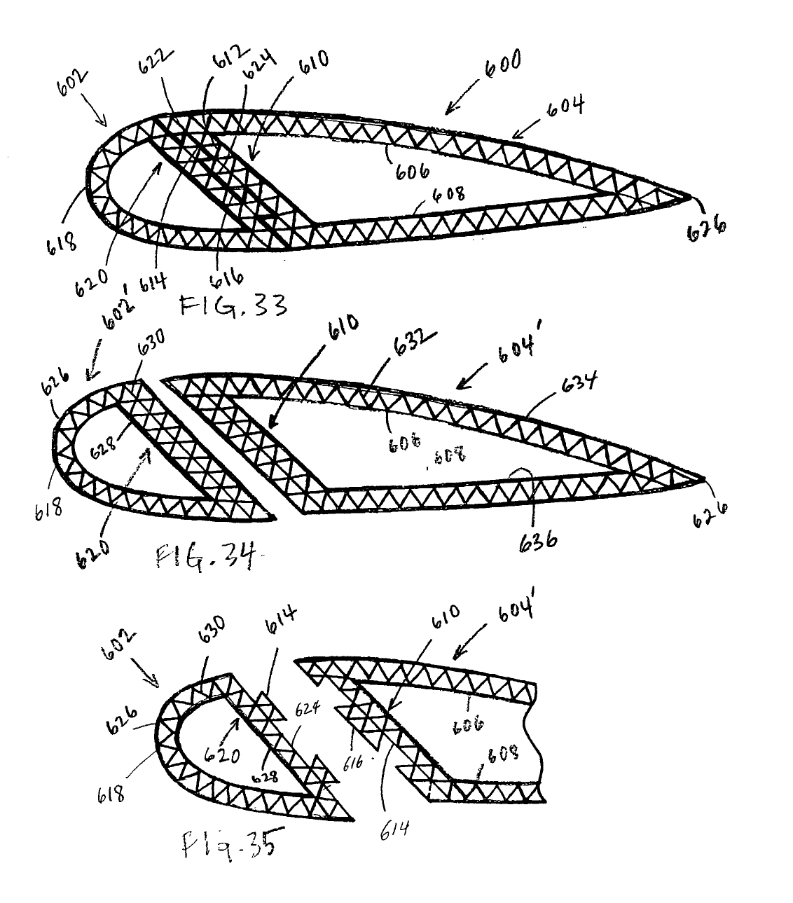

As shown in FIGS. 31 and 32, the trailing section tooling blank 504′ may likewise be formed around a removable mandrel. The triangular tubes 510 are laid out on the mandrel in the configuration shown to form a tooling blank 504′ having multiple layers of tubes 510 at the front wall and including an outer skin 532 and an inner skin 534 (FIG. 31). The assembly is then cured to form an integral unitary body of revolution having a top wall 506 and a bottom wall 508. Furthermore, a cross brace 533 may be used to couple the top and bottom walls together to keep the walls from coming apart and to maintain the integrity of the walls. The final shape of the trailing section 504 (FIG. 32) is obtained by machining away selected layers of tube structure defined by the intersection of cutting planes 548 and 550. As a result, the remaining structure includes top and bottom walls 506 and 508 which diverge forwardly from trailing edge 512 to terminate in respective forward ends 514 and 516. Triangular tubes near the forward ends 514, 516, left behind after the machining stage, cooperate to provide lugs 518 and 520 which project inwardly from top and bottom walls 506 and 508, respectively.

The leading and trailing sections 502 and 504 may then be coupled together, after the curing and machining stages, by sliding the keeper 530 longitudinally into the trailing section 504 engaged behind the respective coupling lugs 518 and 520. It will be appreciated that in the case of a longitudinally tapered wing, such keeper 530 will be tapered outwardly from the root end thereof. The keeper 530 will be bonded or mechanically fastened in place, joined to the respective lugs 518 and 520 to create an integral wing structure. Then, when the resultant aircraft is assembled and the airfoil applied to various loads, the respective filament wound tubes 510 and 524 will cooperate to maintain the structural integrity and shape of the airfoil and of the keeper 530 and the filaments wound thereon will serve to efficiently carry the different bending and torsional loads applied to the wing.

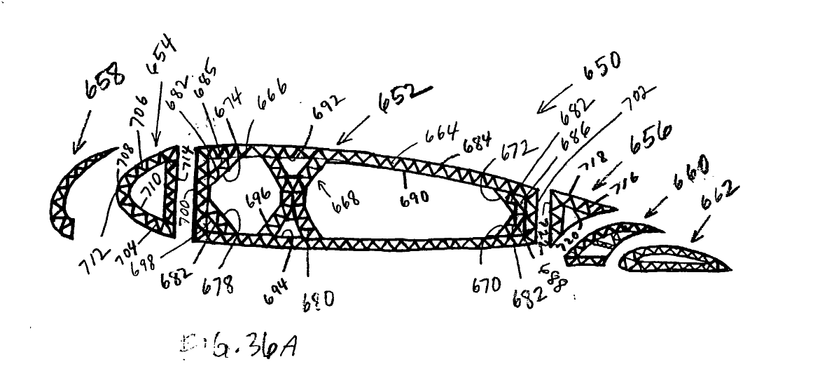

The contoured load bearing structure shown in FIG. 33 is similar to that shown in FIG. 28 and is in the form of an airfoil which might act as an airplane wing, generally designated 600. Such wing is also made up of leading and trailing sections 602 and 604. The trailing section 604 is formed by top and bottom walls 606 and 608 diverging upwardly and forwardly from trailing edge 626. The walls 606, 608 are joined by means of a coupling wall, generally designated 610, constructed by a wall configured by the triangular filament wound tubes 612. Such coupling 610 angles generally downwardly and rearwardly from the front edge of the top wall 606 and is formed with alternate grooves and tongues 614 and 616.

With continued reference to FIG. 33, the leading section 602 is formed with a wall defining a rounded leading edge 618, such wall extending rearwardly to form top and bottom walls joined at their respective rear edges by means of a leading section coupling, generally designated 620. The coupling 620 includes an alternating tongues 622 and grooves 624 shaped complementally to cooperate with the respective grooves 614 and tongues 616 so that such leading and trailing sections 602 and 604 may be coupled together.

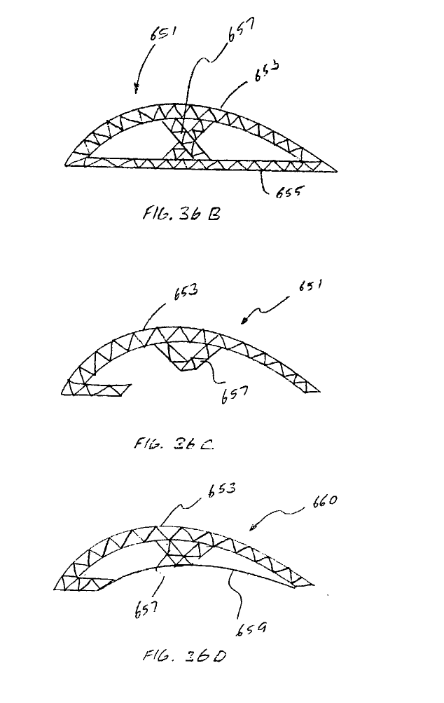

As illustrated in FIGS. 34 and 35, to fabricate the leading section 602 a leading section 602 is formed around a removable mandrel wherein triangular tubes 630 are arranged in the configuration shown (FIG. 34) to define an assembly having an outer skin 626 and an inner skin 628. The assembly is cured and the resulting structure is machined to provide a coupling 620 having grooves 624 and tongues 622.

Likewise, a trailing section tooling blank 604′ is formed around a removable mandrel wherein triangular tubes 632 are arranged in the configuration shown (FIG. 34) to define an assembly having an outer skin 634 and an inner skin 636. The assembly is cured and the resulting structure is machined to provide a coupling 610 having grooves 614 and tongues 616.

The leading section 602 and trailing section 604 are joined by sliding the tongues and grooves together longitudinally and bonding or mechanically fastening them in place as described above with respect to the wing 500. The resultant airfoil structure then provides an integral construction which is lightweight and possesses attractive load carrying abilities. The labyrinth of tongue and groove construction incorporated in the coupling members 610 and 620 form a high integrity bond leaving open areas in the wing for fuel storage tanks, communication lines and the like. Thus, as in the case of the wing 500, the resultant structure affords a highly efficient load carrying structure for the particular loads typically applied to an airfoil.

It will be appreciated that the embodiments depicted in FIGS. 28 and 33 illustrate the construction of hybrid structures having adjoining sections formed with different material combinations. The modular construction of leading section 502, 602 and a trailing section 504, 604 (FIGS. 28 and 33) provides an ability to form structural combinations having desired material properties in a specific regions of the structure. For example, where aerodynamic heating is a concern, leading section 602 may be formed with a composite material which is capable of withstanding elevated temperatures. Alternatively, leading section 602 may be formed with a composite material having ablative properties. In contrast, trailing section 604 may be formed with a different composite material which is capable of providing improved impact resistance, load carrying characteristics, compression strength or the like. Therefore, when the leading section 602 and trailing section 604 are joined to from an integral body, the combined structure will be uniquely tailored to meet various design requirements.

It is also envisioned that the modular style construction mentioned above may be utilized to join a structural section embodying the present invention with a solid metallic or composite section. As a result, the joined sections would cooperate to form a load carrying body having a desired external contour wherein at least a portion of the contour is defined with a combination of triangular tubes.

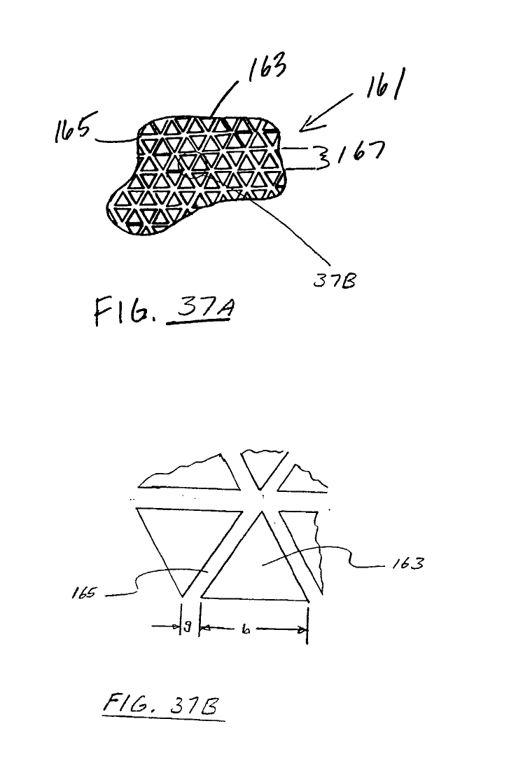

Another embodiment of the present invention, as illustrated in FIG. 36A, includes a wing 650 comprising a wing box 652, leading section 654, trailing section 656, slat 658, and flaps 660, 662. These components are fabricated individually using the techniques disclose above and then joined together to produce a fully integrated wing structure. For example, as illustrated by way of example in FIGS. 36B-36D, the flap 600 may be made by the following process. Initially, as shown in FIG. 36B, a sandwich structure 651 is formed, using the methods described above, having an upper surface 653 and base surface 655; and based on the load, an internal support 657 may also be provided to couple the upper and base surfaces together. The upper surface is contoured to form the desired upper surface of the flap. Next, as shown in FIG. 36C, unwanted sections of the sandwich structure 651 is machined away. Thereafter, as shown in FIG. 36D, to enclose the area that has been machined away, a plate 659 having a convex shape may be attached to the sandwich structure 651, thereby forming an air foil shape flap 660 for nesting. Alternatively, a composite tubular structure may be used to enclosed the sandwich structure 651. Of course, similar process may be used to make the slat. Accordingly, with the above process, flaps and slats with concave inner surfaces can be readily made.

The wing box 652 includes a plurality of elongated thin-walled triangular tubes 664 placed coextensively in a complementary side-by-side fashion which are bonded together to form a hollow core 666 having a desired external contour defining a forward surface 700 and an aft surface 702. The shell can also be integrally formed with an internal support member 668 having an X-shaped cross-section spanning across the hollow interior of the wing box 652, thereby connecting opposite sides of the shell together. The shell is also integrally formed with gussets 670, 672, 674, 678 which extend between adjacent sides of the shell. The legs of the support member 668 and gussets 670, 672, 674, 678 are formed with a plurality of elongated thin-walled triangular tubes 680, 682 which are bonded together in a complementary alternating inverted fashion. Outer skin 685 and inner skins 686, 688, 690, 692, 694, 696, 698, 699 are bonded to the external surfaces of core 666 and cooperate therewith to provide an integrally formed, unitary loading carrying structure.

The leading section 654 includes a plurality of elongated thin-walled triangular tubes 704 placed co-extensively in a complementary side-by-side fashion which are bonded together to form a hollow core 706 having a desired external contour to provide a leading edge 712 and a mating surface 714. Outer skin 708 and inner skin 710 are bonded to the external and internal surfaces of core 706 and cooperate therewith to provide an integrally formed, monoque body of “sandwich” style construction. It will be appreciated that the mating surface 714 of the leading section may be mechanically fastened or bonded to the forward surface 700 of the wing box 652. As such, the leading section 654 and wing box 652 cooperate to form integrated load bearing structure.

Similarly, trailing section 656 includes a plurality of triangular tubes 716 disposed between an outer skin 718 and an inner skin 720. The trailing section may be cured and machined as previously described to provide a mating surface 722 and a desired trailing edge contour 724. The mating surface 722 may then be mechanically fastened or bonded to the aft surface 702 of the wing box 652 wherein the leading section 654, wing box 652, and trailing section 656 cooperate to form an integrated load bearing structure.

Likewise, slat 658, and flaps 660 and 662 are formed of the general construction 10 mentioned above to provide load carrying bodies which may be machined to a desired final external contour. The slat and flaps are then attached to the structural combination formed by the leading section 654, wing box 652, and trailing section 656 to provide a fully integrated wing structure 650.

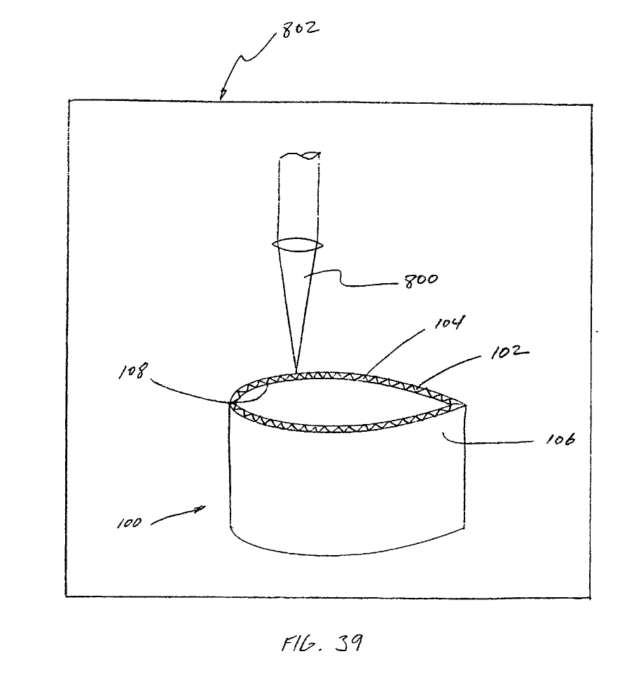

As illustrated by way of example in FIG. 38, the wing structure is not limited to a straight tapered wing design as shown in FIG. 22, rather triangular tubes may be used to construct a curved wing structure 717. Here, the triangular tubes 711 and the mandrels 713 are curved so that when it is wound with fibers it takes on the shape of the desired curved wing structure 717 along the leading edge side 715. Once the fiber wound curved wing structure is cured, the curved mandrels may be withdrawn as before, similar to withdrawing a curved knife from its housing.

From the foregoing, it will be appreciated that the filament wound elongated load bearing structure of the present invention can efficiently and economically be formed to define lightweight hollow structures having highly desirable characteristics for airframes and the like. The resultant structure is particularly efficient in that the various areas and locations within the structure itself can possess different layers and cross-section of filament, different wind or gauge of filament wind and, depending on the particular loads to be carried in that location, the pitch of the wind can be varied for the particular stresses applied to the various selected locations in the structure. The resultant airframe thus is economical to manufacture and will have a long and carefree life.

As illustrated by way of example in FIG. 39, an alternative process of constructing a structure, such as the wing structure 100 of FIG. 1, is a Laser-assisted Chemical Vapor Deposition (LCVD) process by which a solid deposit is formed from gaseous reactants in the presence of high temperatures. LCVD, differs from the traditional Chemical Vapor Deposition (CVD) process in that it uses a laser beam as the heat source. Therefore, instead of uniformly coating the substrate and furnace walls with the CVD process, a localized deposit forms near the focus of the laser beam to form material deposits. As the fiber grows the substrate or the laser may be pulled away at a speed matching the fiber growth rate.

As an example, a laser beam 800 may be programmed to trace the cross-section of the wing structure 100 shown in FIG. 39, i.e., the triangular tubes 102 forming the core 104, and the outer skin 106 and the inner skin 108, all within a gaseous reactant chamber 802. Accordingly, a layer of localized deposition of fibers would occur as the laser beam passes through the cross-section of the structure due to the heat generated from the laser. Of course, the laser beam would make a number of passes through the cross-section, each time laying an another layer on top of the previous layer of material, until the structure is formed. Additionally, the internal support member 126, as shown in FIG. 2, may also be formed through the LCVD by tracing the laser beam through the cross section of the support member 126.

With regard to strength, fibers formed of carbon may carry a load level of about 600,000 PSI to 1,000,000 PSI. Due to its high strength, wing structure formed from the LCVD process can have significant strength to weight ratio improvement.

In closing, it is noted that specific illustrative embodiments of the invention have been disclosed hereinabove. However it is to be understood that the invention is not limited to these specific embodiments. For example, the present invention may be used to construct bicycle frames, boat hulls, vehicle frames, concert stages where the stage is put together and taken down frequently, walls and roofs for homes and commercial buildings, and roads where a plurality of predetermined length of planner tubular constructions may be laid over or elevated above a road site. In other words, the present invention is not limited to the embodiments discussed above. With regard to manufacturing, extrusion process may also be used to manufacture the wing structure, if the cross-sectional area of the wing is constant. With respect to the claims, it is applicant's intention that the claims not be interpreted in accordance with the sixth paragraph of 35 U.S.C. §112 unless the term “means” is used followed by a functional statement.

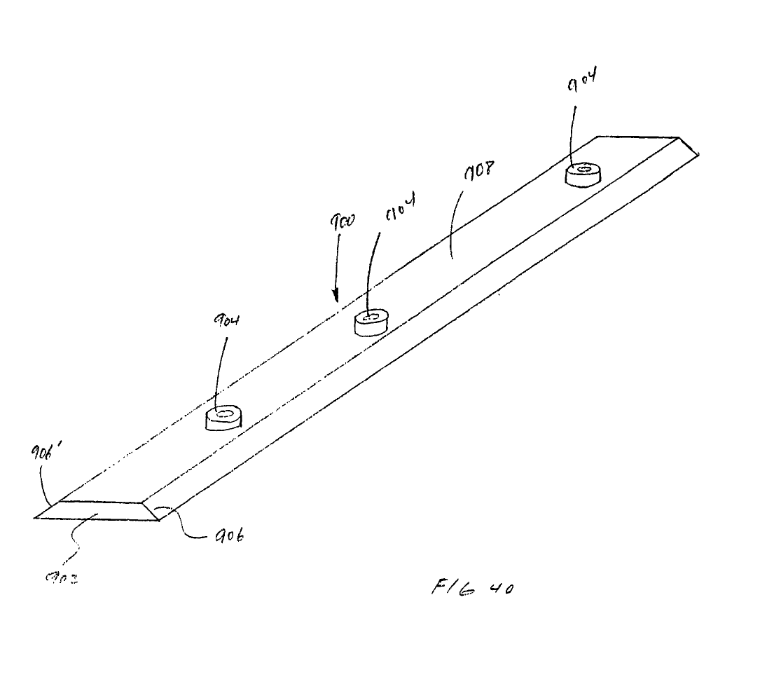

FIG. 40 illustrates by way of example a strip-tie 900 designed to easily and securely couple two structures made of triangular tubes together. The strip-tie 900 includes a base 902 and a plurality of nuts or locking inserts 904. The base 902 may have edges 906 and 906′ that are beveled so that the cross-sectional view of the base 902 forms a trapezoidal shape, for example. Moreover, the strip would be beveled along its length such that, in combination with the geometric shape of the inside of a triangular tube, the strip will nest inside a triangular tube. The nuts would be located over holes in the strip that allow fasteners to pass through the strip. These holes would be precisely located on the strip using tooling that may include coordinate measuring machines, jigs, or any other method known to a person skilled in the art. Along the top side the base 902 is the plurality of nuts that are separated by a predetermined distance.

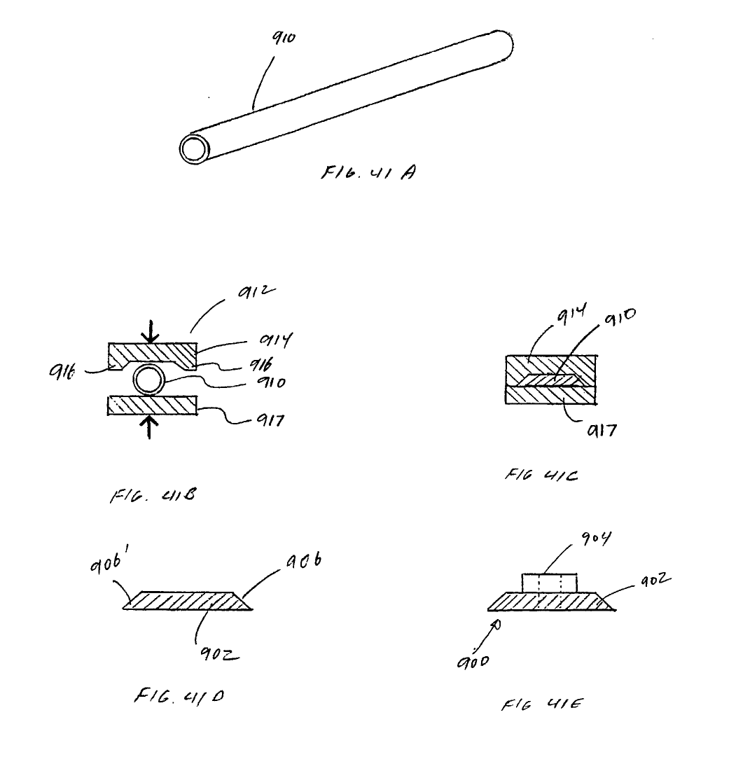

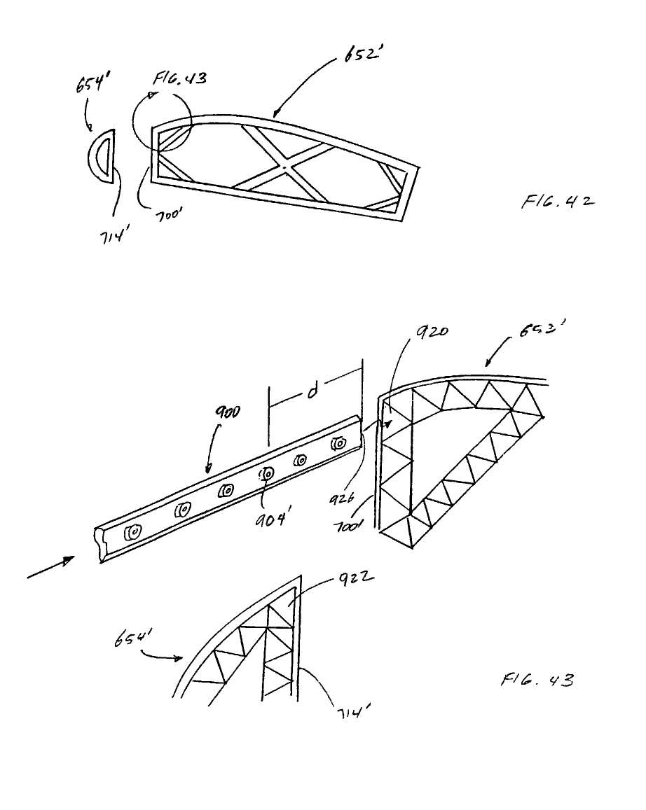

FIGS. 41A-41E illustrate by way example, one exemplary method for forming the strip-tie 900. As shown in FIG. 41A, a tubular member 910 may be initially formed from filament wound fibers as discussed above. To shape the tubular member 910, it may be formed on mandrel that has a variety of cross-sectional shapes, such as a circle, triangle, square, and oval shape. In FIG. 41B, the tubular member 910 is then placed within a press 912 having an upper jaw 914 and a lower jaw 917. In this embodiment, the upperjaw 914 may have lips 916 that are beveled. Accordingly, as illustrated in FIG. 41C, when the upper jaw 914 is compressed against the lower jaw 916, the tubular member 910 is conformed to have the edges 906 and 906′ that are beveled as well. That is, as shown in FIG. 41D, the tubular member 910 is shaped to form the base 902. Then, as shown in FIG. 41E, a plurality of nuts 904 are coupled to the base 902 so that they are a predetermined distance apart from each other, thereby forming the strip tie 900 as shown in FIG. 40. The nuts 904 may be bonded to the base 902 by using adhesives for example. By way of reference, the word “nut” may be any form of receptacle meant to receive and retain a bolt or other form of fastener. Put differently, the word “nut” may mean any method or apparatus that is sued to couple the fastener or bolt, and release the fastener when so desired. Moreover, other method and apparatus developed in the future may be used as well.

Alternatively, the nuts may be flushed within the base 902 rather than protruding from the base as shown in FIG. 41E. To do so, a cavity may be formed within the base 902 so that a nut may be placed in the cavity. Still another alternative is to machine the base 902 along a predetermined location to form the thread within the base 902 itself to receive a screw, thereby eliminating the need for the nuts.

Note that FIGS. 41A-41E illustrates one method of forming the strip-tie 900, however, other methods known to one skilled in the art are within the scope of the present invention as well. For example, the edges 906 and 906′ may be machined to form the beveled edges; rather than being formed from the lips 916 that are beveled. Still another alternative is to mold the base 902 from rubber or plastic material. Yet another alternative is to make the base 902 from metal such as aluminum. Note, if the base 902 is made of alternative material that is different from the material used to make the triangular tube, i.e., other than composite material with fibers, then the modulus of elasticity of that material is preferably similar to the material used to form the triangular tube. This way, the stress between the triangular tube and the base is minimized during the thermal expansion and contraction between the two structures.

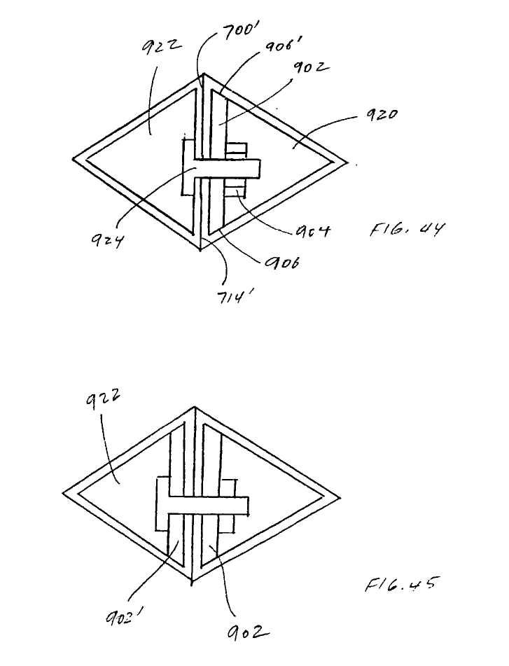

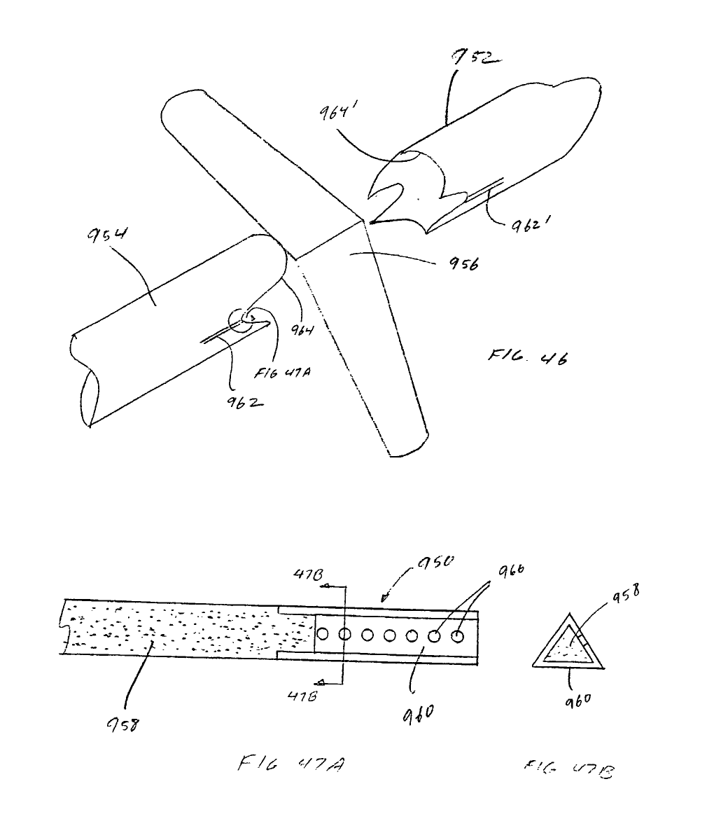

As illustrated by way of example in FIGS. 42 and 43, the strip-tie 900 may be used to couple the leading section 654′ and the wing box 652′ together. To do so, the strip-tie 900 is inserted into the triangular tube 920 with the base of the strip-tie 900 adjacent to the forward surface 700′. Then the mating surface 714′ of the leading section 654′ may be coupled to the forward surface 700′ of the wing box by running a bolt through the corresponding triangular tube 922 in the leading section 654′ and the triangular tube 920 in the wing box 652′. That is, as illustrated by way of example in FIG. 44, the bolt 924 passes through the tube 922 along the mating surface 714′, the tube 920 along the forward surface 700′, the base 902, and then locks with the corresponding nut 904. Moreover, access holes may be formed throughout the leading section 654′ to allow bolts 924 to reach surface 714′, such that installation and removal of bolts is allowable. Note that the beveled edges 906 and 906′ of the base 902 are flushed against the interior side of the triangular tube 920 so that there is very little play, if at all, between the tube 920 and the strip-tie 900. That is, the strip-tie 900 is wedged in the triangular tube 920 by the edges 906 and 906′ and, therefore securely held within triangular the tube 920. This method may be used to couple composite and non-composite structures such as trailing sections such as flaps, aelerons, speed brakes, fairings, tailplanes, rudders, elevators, etc.

To ensure that the bolt 924 and the corresponding nut 904 are positioned properly with respect to one another, the same predetermined distance used to positioned the nuts 904 on the base 902 may be used to drill a hole for the bolt 924 between the mating surface 714′ and the forward surface 700′. This way, the bolt 924 will align with the corresponding nut 904 properly. For example, to put a bolt through the nut 904′ in FIG. 43, that is “d” distance from the outer or leading edge 926, a hole may be drilled along the mating surface of the tube 922 distance “d” from the outer or leading edge 926 as well so that the bolt 924 will align with the nut 904′. Alternatively, the same set up and tool that was used to drill the holes in the base 902 may be used to drill the holes in the triangular tubes 920 and 922.

Alternatively, as illustrated by way of example in FIG. 45, a second base 902′ having holes drilled in the same positions as the holes in the base 902 may be inserted into the tube 922 as well. To drill the holes along the mating surface 714′ of the tube 922 correctly, the base 902′ may be positioned along the exterior side of the mating surface 714′ then holes may be drilled using the holes in the base 902′ as a guide. Once all of the holes are drilled, the holes in the base 902′, the holes in the tube 922, the holes in the base 902 will align properly for the bolt 924 to pass through and lock with the corresponding nut 904. Of course, the same holes may be drilled in the tube 920 along the forward surface side as well using the base 902 or 902′ as a guide. Still another alternative is to use the same tool that was used to drill the holes in bases 902 and 902′ may be used to drill the holes in the tubes 920 and 922.

There are several advantages to using the strip-tie 900 to couple one structure to another. One of the advantages is that the strip-tie 900 as it runs across the wing box, adds strength to the structure such as the wing box. Another advantage is that the nut within the tube is self-locating and therefore it is much easier to install a structure such as the leading section 654′ to the wing box 652′. Yet another advantage is that if the nut should ever dislodge from the base 902, the strip-tie 900 may be easily removed from the tube and the nut may be reattached to the base, and the stripe tie 900 may be reinserted to the tube.

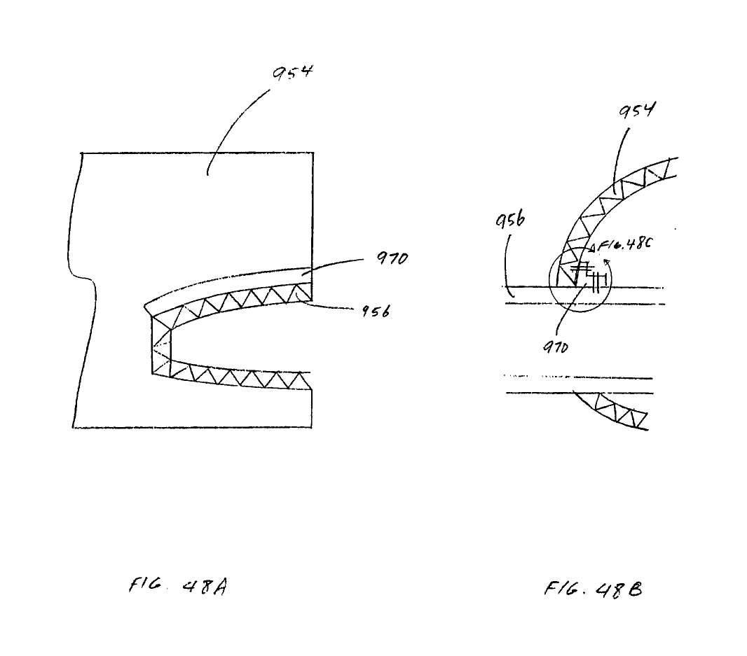

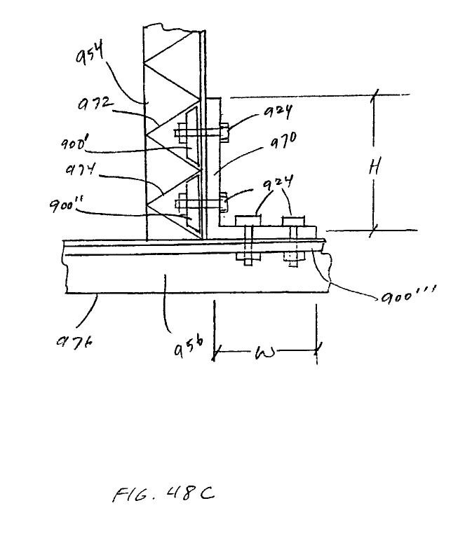

FIGS. 46, 47A, and 47B, illustrate by way example a system and method for coupling the front and back fuselages 952 and 954, respectively, around a wing 956. In this embodiment, the mandrel 950 that is used to form the triangular tube includes a foam portion 958 and a triangular tube tie portion 960. The triangular tube tie portion 960 may be made of a variety of materials such as composite and metal. As shown in FIG. 47A, one end of the foam portion 958 is shaved so that one end of the triangular tube tie portion 960 may slide over the shaved area of the foam portion 958. And as discussed above, fibers are wound around the mandrel 950 along the foam 958 and the triangular tube tie portions 960, in a controlled orientation to form a triangular tube 962 in the back fuselage 952, for example (see FIG. 46). The triangular tie portion 960 has a plurality of holes 966 and each hole is positioned in a predetermined distance apart from each other. This way the location of each of the holes is known relative to each other.

As illustrated by way of example in FIG. 47B, in this embodiment, the mandrel 950 is not removed from the triangular tube 962 so that the triangular tube 962 is filled with both the foam portion 958 and the triangular tube tie portion 960. Once the triangular tube 962 has been formed in the fuselage sections 952 holes may be formed throughout the windings which coincide with the holes 966 in triangular tube tie portion 960. This way, a bolt 924, for example, may penetrate through the holes in the windings and the bolts 966 in the triangular tube tie portion 960. Alternately, the holes 966 may be formed simultaneously with the holes in the windings in one operation.

Moreover, a mating triangular tube 962′ that is similar to the triangular tube 962 may be position in the front fuselage 952 as well (see FIG. 46); positioned so that the triangular tube tie portions from both the triangular tubes 962 and 962′ are facing each other. To tie the front and back fuselages 952 and 954 together, a number of the triangular tubes along the mating edges 964 and 964′ from the respective back and front fuselages 952 and 954 may incorporate the triangular tube 962 as described above. Note that each of the triangular tubes may be wound in a controlled manner to maximize the structural strength of the respective triangular tube depending on the stresses applied to that triangular tube. Once the front and back fuselages 952 and 954 are brought together, they may be tied together by placing a strip-tie 900 inside across the triangular tube tie portion of the triangular tubes 962 and 962′. That is, the stripe ties 900 are used to tie each of the corresponding triangular tubes along the mating edges 964 and 964′ together, thereby coupling the two fuselages together.

One of the advantages with using the mandrel 950 is that the foam left in the triangular tube insulates the fuselage from the cold, heat, and noise. This means that separate foam panels are no longer needed with the present invention; unlike commercial aircraft that have interior panels to insulate the fuselage. This of course saves manufacturing time and cost. Moreover, the fuselage may be made of smaller sections and coupled together with the triangular tubes 962 and strip-ties 900 so that the design of the fuselage is not limited to one large fuselage. Moreover, with the fuselage divided into smaller sections, if any one of the sections should get damaged, just that section can be replaced or repaired. This of course saves time and money in repairing the aircraft.

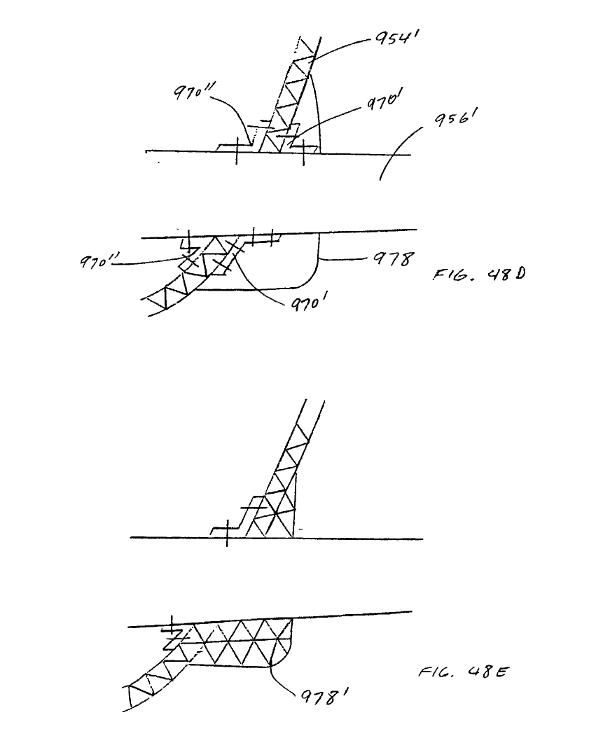

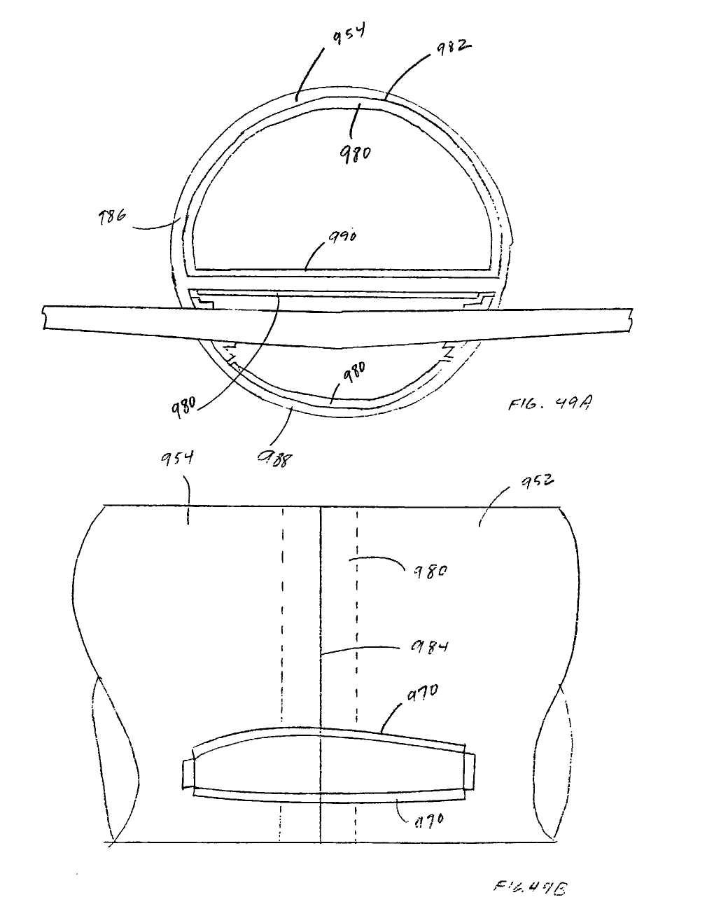

FIGS. 48A-48E, illustrates by way of example a flange 970 for coupling the fuselage 954 to the wing 956. Note that FIGS. 48A-48C show that the longitudinal axis of the triangular tubes for the fuselage and the wing are generally perpendicular to each other. As best shown in FIG. 48C, the flange 970 shaped like a “L” contours around the surface of the wing 956 and is flushed against the inner side of the fuselage 954. The flange 970 has a height “H” and a width “W” each dimensions variable depending on the number o bolt(s) 924 that is used. In this embodiment, the height “H” and width “W” are selected so that at least two bolts 924 may be used along the height and width sides of the flange 970. To do so, a first stripe tie 900′ is inserted into the triangular tube 972 in the fuselage, a second stripe tie 900″ is inserted into the triangular tube 974 in the fuselage, and a third strip-tie 900′″ is inserted into the triangular tube 976 on the wing 956. Knowing the location of each of the nuts on the stripe ties 900′, 900″, and 900′″, holes are drilled into the flange 970 so that when the bolts 924 are inserted into the holes in the flange 970, the bolts match up with its respective nuts in the strip-ties. Then, the bolts are tightened to couple the fuselage 954 to the wing 956.

FIG. 48D illustrates by way of example a pair of exterior flanges 970′ that is used to attach the wing 956′ to the exterior side of the fuselage 954′. Moreover, a pair of interior flanges 970″ is used to attach the wing 956′ to the interior side of the fuselage 954′. That is, the flanges assist in distributing the loads from the wing to the fuselage. To minimize air resistance along the exterior side of the fuselage 954′, a wing faring 978 may be used to encapsulate the pair of flanges 970′ along with a portion of the fuselage 954′ and the wing 956′.

FIG. 48E illustrates by way of example a wing faring 978′ that is formed from layers of triangular tubes. The wing faring 978′ in this embodiment is formed from layers of triangular tubes to distribute the load from the wing to the fuselage; moreover, the wing faring 978′ is shaped to be aerodynamic to minimize air resistance and therefore reduce drag. Of course, the flange 970 may contour around the entire circumference of the wing 956, as shown in FIG. 49A. With regard to material, the flange 970 may be made of composite material with fiber, where the fibers are wounded in controlled orientation to maximize the strength of the flange 970. Alternatively, the flange 970 may be made of any other material known to one skilled in the art (metal, plastic, etc.).

FIGS. 49A and 49B illustrate by way of example a doubler 980 used to strengthen the joint areas between the front fuselage 952 and back fuselage 954. That is, the doubler 980 may be shaped like a ring and is applied to the interior side of the fuselage and overlaps the jointed areas 984 between the front 952 and back 954 fuselages. In other words, the doubler adds another layer of material along the interior side of the fuselage. This way, the front and back fuselages are supported by both the strip-ties 900 around the fuselage and the doubler 980. Moreover, to pressurize the fuselage, a sealant 982 may be applied between the doubler 980 and the front/back portions of the fuselage that mate with the doubler 980. The doubler 980 may be made of sheet metal, composite, rubber, or any material known to one skilled in the art. Note that the sealant may be any material known to one skilled in the art such as rubber. Alternatively, the doubler 980 may be applied along the exterior side of the fuselage. Moreover, the doubler may be coupled to the interior side of the fuselage by using a bolt 924 that runs through the doubler 980, interior skin of the fuselage, the respective triangular tube, the base 902, and to the nut 904. Of course, other method known to one skilled in the art may be used to couple the doubler to the inside of the fuselage.

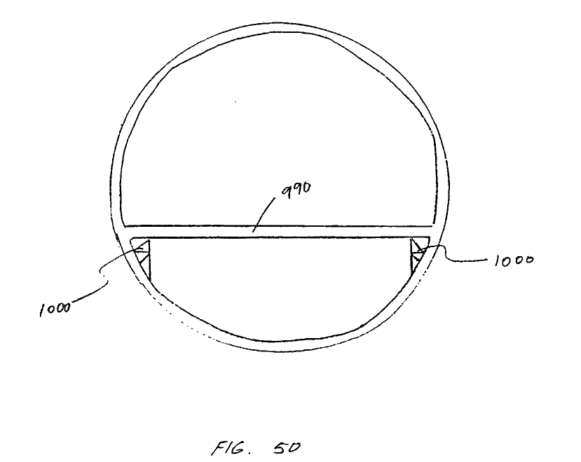

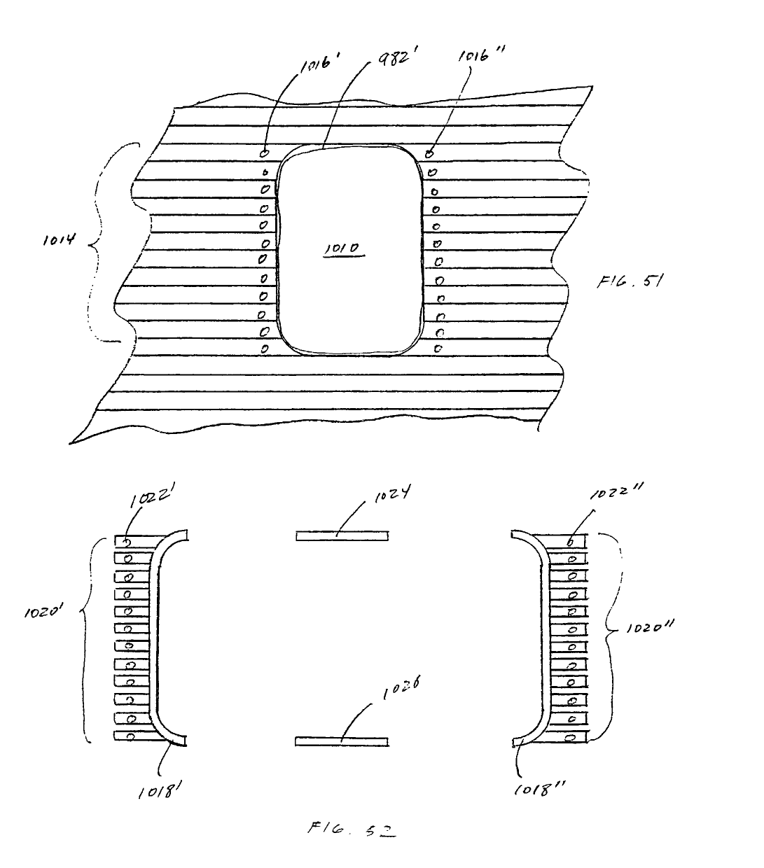

FIG. 50 illustrates by way of example a pair of integrally formed supports 1000 that may be formed underneath the floor 990 for extra support on the floor if needed. These would also use colocated triangular tubes to form the insides of the supports.

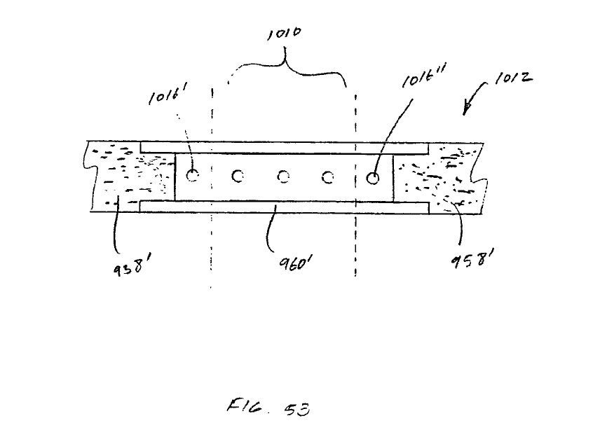

FIGS. 51-55 illustrate by way of example a system and method for installing a window in the fuselage and a cover for the window. FIG. 51 shows the interior side of the fuselage with a window opening 1010 cut out from a predetermined location along the fuselage. As shown by way of example in FIG. 53, in the window cut out area 1010, the mandrel 1012 that is used to wind each of the triangular tubes 1014 (FIG. 51) has an intermediate triangular tube tie portion 960′ in between two foam portions 958′. The window opening 1010 is cut in a predetermined area so that the holes 1016′ and 1016″ are left on each sides, i.e., the left side hole 1016′ and the right side hole 1016″. Moreover, as shown in FIG. 51, the holes 1016′ and 1016″ are shown from the inside of the fuselage once the layers of fiber forming the triangular tubes 1014 are removed hiding the holes 1016′ and 1016″. Note that the location of the holes 1016′ and 1016″ may be easily found because they are located in a predetermined location from relative reference point.

With the window opening 1010 formed, a left window frame 1018′ may be installed with the same or fewer number of plugs 1020′ as there are triangular tubes 1014. In other words, a plug 1020′ may be inserted into some or all of the triangular tubes 1014. Each of the plugs 1020′ also has a hole 1022′ that corresponds to the left side holes 1016′. Moreover, each of the plugs may have a strip-tie 900 so that a bolt 924 may be inserted through the holes 1016′, 1022′ and secured to the nut on the strip-tie 900. To pressurize the fuselage, a sealant or rubber 982′ may be used between the opening and the left window frame 1018′. Then, the right window frame 1018″ may be installed along the right side of the window opening 1010 as well. Thereafter, the upper window frame 1024 and the lower window frame 1026 may be used to finish the window frame for the opening 1010. Then a transparent material such as plastic or glass may be installed within the window frame to complete the window in the fuselage. Alternatively, adhesives may be used to bond the plugs 1020′ to the triangular tubes 1014; rather than using the bolts to couple the window frames to the fuselage.

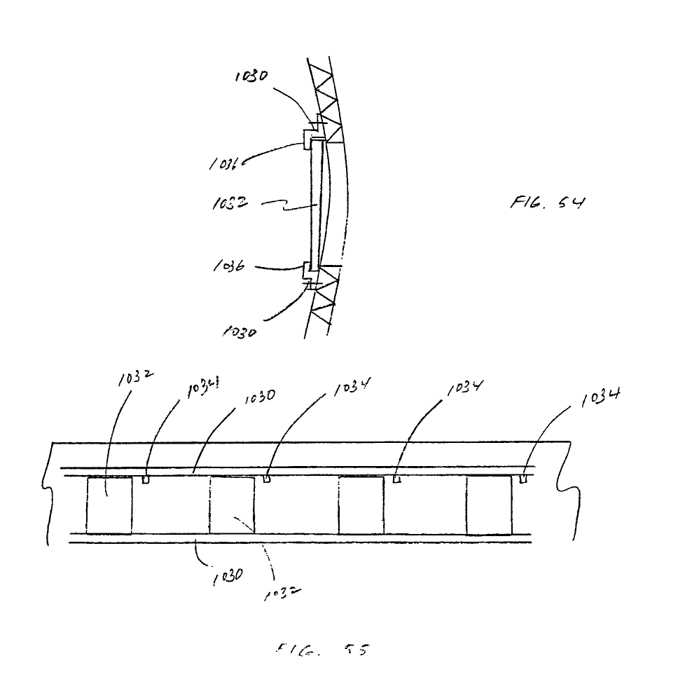

FIGS. 54 and 55 illustrate by way of example a system and method for installing covers for the windows in the fuselage. In this embodiment, a pair of railings 1030 are coupled to the interior side of the fuselage using a combination of strip-ties 900 and bolts 924 as described above. Each railing 1030 has a hook 1036 that is used to hold a cover 1032 so that the cover may slide to the left and right. In this embodiment, when the cover 1032 is pushed to the right it covers the window. Moreover, the covers may slide horizontally within the railings 1030 between the two stoppers 1034. One of the advantages with this embodiment is that installing window covers on a fuselage is streamlined. In traditional airplanes, the window covers move up and down, and they are installed individually within the foam panels. With the present invention, the railings 1030 may extruded and installed along the longitudinal axis of the fuselage. Then a cover 1032 for each of the windows is inserted into the railings 1030. To position each of the covers within the respective position of each of its windows, the stoppers 1034 may be placed in between each of the windows. Thus, the railings for all the windows are installed in one step rather than individually for each window.

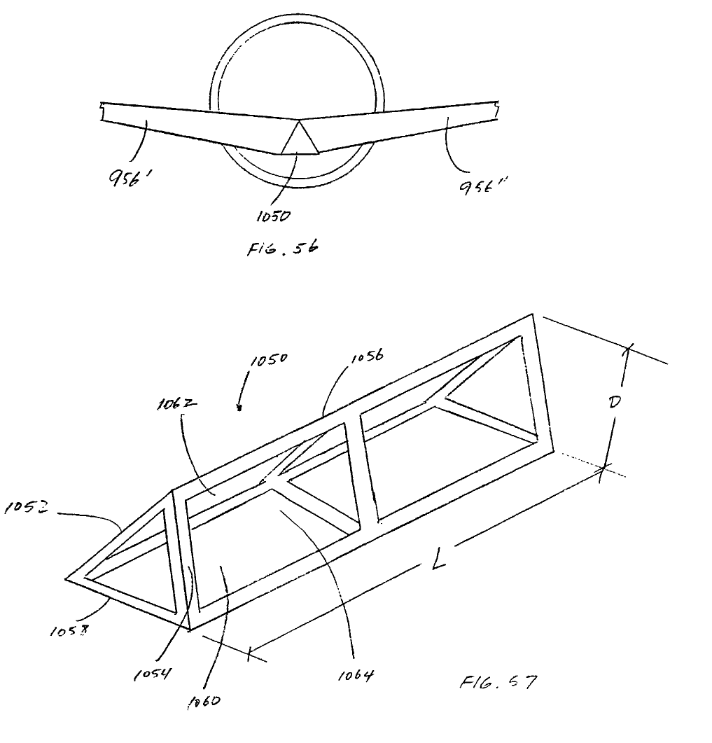

FIGS. 56-58 illustrate by way of example a wing tie 1050 for coupling the left wing 956′ to the right wing 956″ and allowing the coupled wings to be inspected. That is, even after the two wing sections have been attached, the interior of the wing sections needs to be periodically inspected. And if any problem is detected, then there needs to be a way to get to the problem and fix it. For example, if the fuel pump installed within the wing is not working, then there needs to be a way of getting to the fuel pump and fix the problem. Same is true if one of the bolts is loose or fatigued.

As illustrated by way of example in FIGS. 56-58, the left wing 956′ is attached to the left side 1052 of the wing tie 1050 and the right wing 956″ is attached to the right side 1054 of the wing tie 1050. Moreover, the depth “D” and length “L” of the wing tie 1050 is substantially the same as the depth and length of the wings 956′ and 956″. Along the tip 1056 of the wing tie 1050, the wings 956′ and 956″ may be coupled to each other. That is, the top surface areas of the wings 956′ and 956″ may be bolted together, as discussed further below. Of course, the tip of the wings 956′ and 956″ may be also attached to the wing tie 1050 as well. Below the tip 1056, the left wing 956′ is coupled to the left side 1052 and the right wing 956″ is coupled to the right side 1054 of the wing tie 1050, respectively. The top side of the left and right wings may be coupled to each other as illustrated by way of example in FIGS. 59-61. At the bottom 1058 of the wing tie 1050, the left and right wings 956′ and 956″ may be coupled to the wing tie as discussed below.

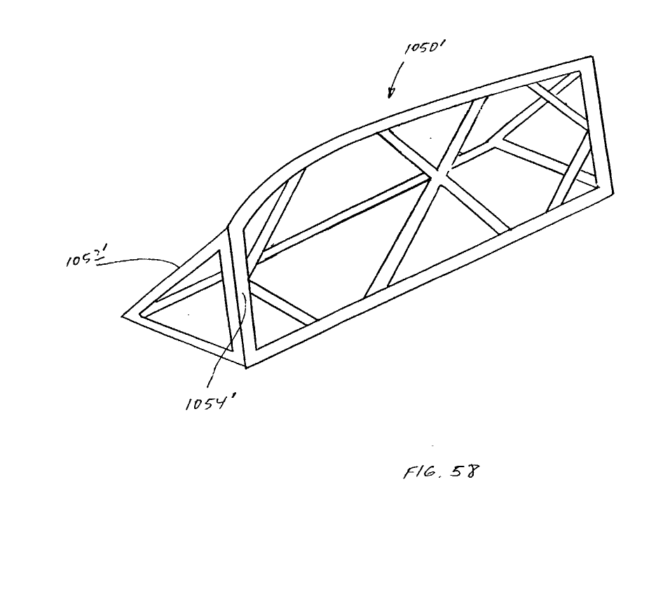

Moreover, as illustrated by way of example in FIG. 58, the left side 1052′ and right side 1054′ of the wing tie 1050′ may be configured to match the cross-section of the wing box 652′ as shown in FIG. 42. This way, the triangular tubes that make up the cross-section of the wing box 652′ may be coupled to the sides 1052′ and 1054′ of the wing tie 1050′.

Referring back to FIG. 57, once the left and right wings are coupled to the wing tie 1050, an inspector may view the interior of the left and right wings through the base opening 1060, and either through the left opening 1062 to view the interior of the left wing 956′ or through the right opening 1064 to view the interior of the right wing 956″. With regard to material, the wing tie 1050 may be made of a variety of materials, such as metal and composite.

FIGS. 59-61 illustrate by way of example a left plug tie 1100 and a right plug tie 1100′ for coupling the left wing 956′ to the right wing 956″. The left plug tie 1100 includes a plug 1104 and a step-tab 1106 that is slightly elevated from the plug 1104. Note that the width “X” of the step-tab 1106 is about one half of the base width “Y” of the left plug 1104, and the step-tab 1106 elevates and protrudes from the right side of the plug 1104. Likewise, the right plug tie 1100′ includes a plug 1104′ and a step-tab 1106′. Note that the left plug tie 1100 is same as the right plug tie 1100′. In this embodiment, the step-tab 1 06 has a pair of holes 1110 that corresponds to a pair of holes 1110′ in the plug 1104′ as further explained below.

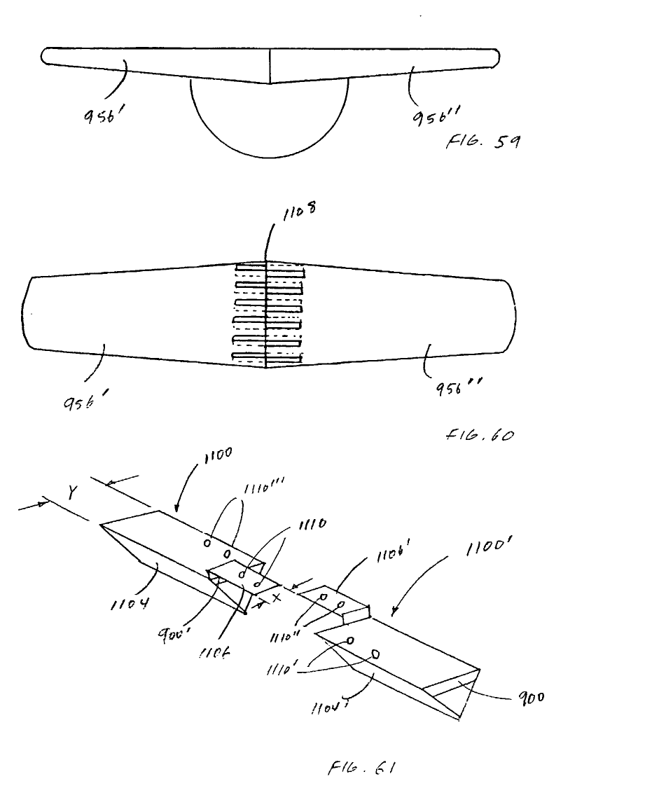

As shown in FIG. 60, to couple the two wings together, the left plug tie 1100 is inserted in to a triangular tube in the left wing 956′. Similarly, the right plug tie 1100′ is inserted into a triangular tube in the right wing 956″. That is, a predetermined number of left and right plug ties 1100 and 1100′ are inserted into the triangular tubes in the left and right wings, respectively. The number of plug ties 1100 and 1100′ that are used depends the stress that is applied along the butted area 1108 between the left and right wings. To maximize the attachment between the left and right wings, every triangular tube that has the base that is parallel with the upper surface of the wing may be inserted with a plug tie.

As shown in FIG. 61, the plug 1104′ has a strip-tie 900 so that the plug ties may be attached to the wing by a bolt that couples the plug tie to the wing. Once all of the predetermined number of plug ties are inserted to its respective left and right wings, the two wings are brought together so that the step-tabs 1106 from the left plug ties 1100 and the step-tabs 1106′ from the right plug ties 1100′ are adjacent to each other as shown in FIG. 60. As such, the pair of holes 1110 in the step-tab 1106 align with the pair of holes 1110′ in the plug 1104′, and likewise, the pair of holes 1110″ in the step-tab 1106′ align with the pair of holes 1110′″ in the plug 1104. Of course, the triangular tubes in the left and right wings are drilled so that a pair of bolts may be driven through the aligned holes 1110 and 1110′ and tighten with the nut on the strip-tie 900; and through the aligned holes 1110″ and 1110′″ and tighten with the nut on the strip-tie 900′, thereby attaching the left and right wings together.

FIG. 59 illustrates by way of example that some aircraft may have the wings located on top of the fuselage. In such a case, the plug ties may be used to attach the left and right wings.

Alternatively, the strip-tie 900 may run across between the plugs 1104 and 1104′ and nuts on the base to match the holes 1110′ and 1110′″ so that the attachment between the left and right wings are made by both the strip-tie 900 and the step-tabs 1106 and 1106′. Referring to the embodiment disclosed in FIGS. 56-58, the top side of the wings may be attached to each other as described above in FIGS. 59-61. With regard to attaching the bottom 1058 of the wing tie 1050 to the left and right wings 956′ and 956″, bolts may be driven through the holes 1110 and through the wing tie 1050 along the bottom 1058 to couple the wings to the wing tie 1050. Still further, although strip-tie 900 may be utilized, to strengthen the attachment between the two wings, it is not necessary for this embodiment. That is, the plugs may be made of metal or other materials that have been threaded to receive the bolt.

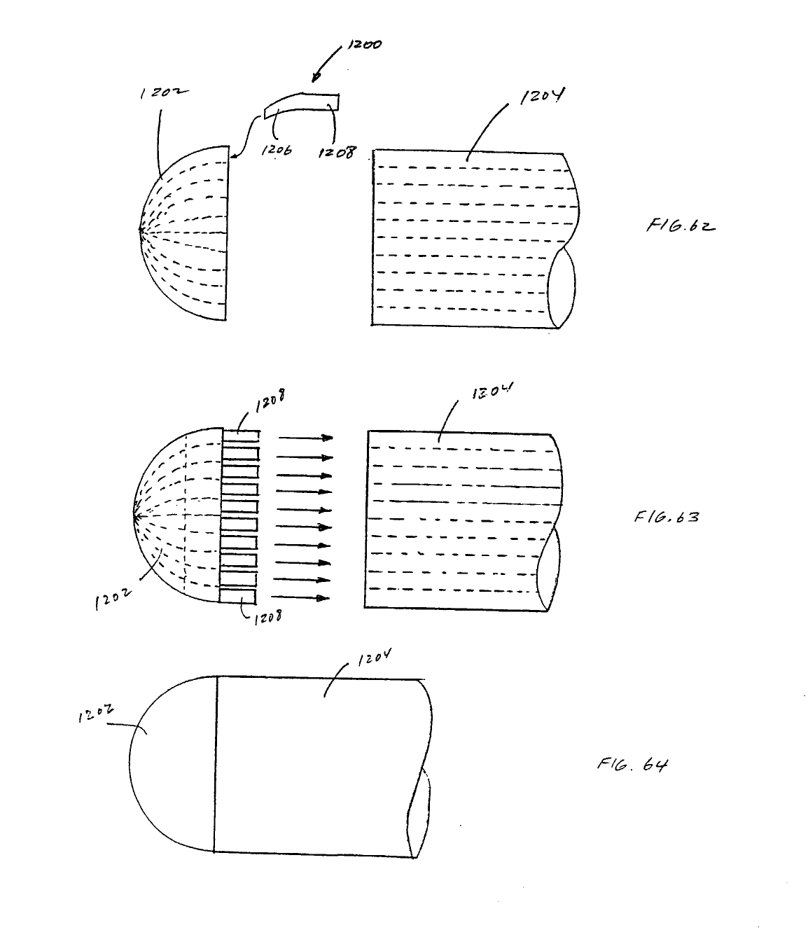

FIGS. 62-64 illustrate by way of example a curve plug 1200 to couple a bulkhead 1202 to a fuselage 1204. The curve plug 1200 has a curved portion 1206 that substantially matches the curved shape of the bulkhead 1202. Moreover, the curve plug 1200 has a straight portion 1208 that may be inserted into the triangular tubes in the fuselage 1204. To couple the bulkhead 1202 to the fuselage 1204, the curved portion 1206 is first inserted into the bulkhead around a predetermined number of triangular tubes in the bulkhead 1202 as shown in FIG. 63. Then, the fuselage 1204 is brought together with the bulkhead so that the straight portion of the curve plug 1200 is inserted into the triangular tubes in the fuselage 1204, as shown in FIG. 64. Then to attach the bulkhead 1202 to the fuselage 1204, the strip-ties 900 may be used as described above and/or adhesives may be used as well. Moreover, as discussed above doubler with a sealant may be used to further strengthen the attachment and to pressurize the fuselage.

1. An elongated load carrying structure of a predetermined curved exterior contour comprising:
a wall formed by a plurality of elongated co-extensive triangular cross-section filament wound tubes nested complementally together in juxtaposition and arranged to cooperate together in forming at least a portion of a hollow shell defining a body of revolution having said predetermined exterior contour;
a bond bonding said tubes together; and
an outer skin covering the exterior surface of said shell.

2. An elongated load carrying structure as set forth in claim 1 for carrying a predetermined load wherein:
said tubes are wound with filaments oriented and arranged to efficiently carry said predetermined load.

3. An elongated load carrying structure as set forth in claim 1 wherein said exterior cross section is a fluid foil and wherein:
said tubes are arranged to define the shape of said shell as said fluid foil.

4. An elongated load carrying structure as set forth in claim 1 wherein:
said tubes are wound with filaments having a helical pitch from 0° to 90° to the longitudinal axis.

5. An elongated load carrying structure as set forth in claim 1 wherein:
said skin is filament wound.

6. An elongated load carrying structure as set forth in claim 3 wherein:
said foil is in the shape of an airplane wing; and
said tubes are arranged to cooperate in forming a leading edge, round in transverse, also an acute angle trailing edge.

7. An elongated load carrying structure as set forth in claim 1 wherein:
said tubes are hollow to form longitudinal passages therein.

8. An elongated load carrying structure as set forth in claim 1 wherein:
said tubes are formed with respective equilateral cross sections.

9. An elongated load carrying structure as set forth in claim 1 wherein:
said tubes are wound with selected sections having one wall thickness and other sections having a different wall thickness.

10. An elongated load carrying structure as set forth in claim 1 that includes:
a strut device in said shell extending from one side to the other thereof.

11. An elongated load carrying structure as set forth in claim 10 wherein:
said strut device includes elongated filament wound triangular tubes located side by side and nested together.

12. An elongated load carrying structure as set forth in claim 1 wherein said structure is a fuselage and wherein further:
said tubes are arranged to cooperate in forming said shell with a circularly shaped said exterior contour.

13. An elongated load carrying structure as set forth in claim 1 wherein:
said structure is a fluid foil; and
said tubes are arranged to form discrete leading edge and trailing edge sections; and
said skin is arranged to cover said sections.

14. An elongated load carrying structure as set forth in claim 13 wherein:
said leading and trailing edge sections are configured with conforming sides configured with respective abutting sections that abut together and inclined recess sections cooperating to, when said abutting sections are abutted together, form cavities of selected configurations; and
filament wound filler tubes configured for complemental receipt in said cavities.

15. An elongated load carrying structure as set forth in claim 1 wherein:
said tubes are configured with uniform cross sections along the irrespective length.

16. An elongated load carrying structure as set forth in claim 1 wherein said structure is formed to project longitudinally with said exterior contour tapering laterally inwardly in one direction along the length thereof and wherein further:
at least some of said tubes angle laterally inwardly toward one another in said one direction.

17. An elongated load carrying structure as set forth in claim 1 wherein:
said tubes are arranged to configure said wall to form leading and trailing wing sections.

18. An elongated load carrying structure as set forth in claim 17 wherein:
said tubes are arranged to configure said trailing section with top and bottom walls projecting forwardly from a trailing edge and diverging from one another;
said trailing section being configured at its forward extremity with a first coupling;
said leading section being configured with a rounded leading edge with respective top and bottom walls projecting rearwardly; and
said leading section being formed at its rear extremity with a second coupling for complementally coupling with said first section.

19. An elongated load carrying structure as set forth in claim 18 wherein:
said tubes are arranged to form said wall configured to define said first and second couplings.

20. An elongated load carrying structure as set forth in claim 18 wherein:
said first coupling includes lugs mounted on the respective top and bottom walls of said trailing section; and
said second coupling includes a keeper engageable behind said lugs.

21. An elongated load carrying structure as set forth in claim 18 wherein:
said first coupling includes dovetail grooves; and
said second coupling includes tongues complementally received in said grooves.

22. An elongated load carrying structure as set forth in claim 1 wherein:
said tubes are arranged in juxtaposition and in a circular pattern to form said wall as a fuselage section.

23. An elongated load carrying structure as set forth in claim 22 wherein:
said tubes are arranged to configure said wall in a circular pattern and include longitudinal and helical filaments.

24. A structure as set forth in claim 1 wherein:
said tubes are trapezoidal in cross-section.

25. A structure as set forth in claim 1 wherein:
said tubes are arranged to form a wing box.

26. A structure as set forth in claim 1 wherein:
said tubes are arranged to form a hollow wing structure and includes a further plurality of triangular cross-section filament wound tubes juxtaposed in the interior of said wing structure and bonded together to cooperate in forming one or more gussets.

27. A structure as set forth in claim 1 wherein:
said tubes are arranged to cooperate in forming the wall of a wing section; and
said structure further includes a further plurality of elongated co-extensive juxtaposed triangular in cross-section filament wound hollow tubes arranged together to define, in cross-section, a generally crescent shape defining a wing slat to be connected to the front of said wing section.

28. A structure as set forth in claim 1 wherein:
said filament wound tubes are arranged to cooperate in forming the wall of a trailing wing section, and wherein:
said structure includes a plurality of elongated co-extensive triangular in cross-section filament wound hollow tubes arranged to form a slat section configured for attachment to said trailing wing section.

29. A structure as set forth in claim 27 wherein:
further tubes are arranged to form said flap in the form of split flaps.

30. A structure as set forth in claim 1 wherein:
said tubes are arranged to cooperate in forming the entire wall of said shell.

31. A method of making a composite contoured structure for carrying a load and wall of a shell including:
selecting triangular cross-section hollow tubes, filament wound in a pattern;
assembling said tubes together in co-extensive side by side relationship to form the defining predetermined curved cross-sectional exterior contour; bonding said tubes together;
applying a skin to at least one surface of said shell; and bonding said skin to said shell.

32. The method of claim 31 that includes:
selecting said tubes configured with a transverse cross section of an isosceles triangle shape.

33. The method of claim 31 that includes:
placing said tubes in a configuration to form said shell in the shape of a fluid foil.

34. The method of claim 31 that includes:
placing tubes to form said shell in the configuration of the cross section of an airplane fuselage.

35. The method of claim 31 that includes:
winding said tubes with filament having first sections with a first wall thickness and second sections with a thicker wall thickness for carrying heavy loads.

36. The method of claim 31 that includes:
arranging said tubes to form said wall of said shell to taper inwardly longitudinally in one direction along the length thereof and wherein:
the step of placing said tubes includes placing at least some of said tubes to angle longitudinally in said one direction and angling inwardly toward the other tubes.

37. The method of claim 31 for forming said structure with said contour as a rounded exterior cross section and that includes:
forming at least selected ones of said tubes with one side wall thereof rounded and positioning said selected tubes so that said rounded sides thereof face exteriorly outwardly in said shell to cooperate in forming said rounded exterior cross section.

38. The method of claim 31 that includes making said structure with an anchor section and that includes:
making a filament wound plug to be complementally received in one of said tubes;
placing said plug in said one of said tubes;
bonding said plug in said tube to form said anchor section.

39. The method of claim 31 that includes:
making said tubes over mandrels having respective walls which taper inwardly from one end to the other.

40. The method of claim 31 for making a fluid foil for connecting to a body and that includes:
making a fitting configured with mounting plugs formed with a predetermined triangular cross section; and
the method of making said tubes includes making at least one end of selected ones of said tubes with an interior cross section constructed to be complementally fitted over respective ones of said plugs.

41. The method of claim 31 wherein:
the step of assembling said tubes includes selecting a mold and placing said tubes against the wall of said mold.

42. The method of claim 41 wherein:
said mold is selected as a male mandrel.

43. The method as set forth in claim 31 wherein:
the bonding of said tubes together includes applying a bond to the confronting walls of said tubes and concurrently curing said bond.

44. The method as set forth in claim 44 wherein:
said bonding step of said shell is performed concurrent with the bonding of said tubes.

45. The method as set forth in claim 31 wherein:
said tubes are arranged to form first and second discrete sections of a fluid foil; and
a further plurality of said tubes are arranged to form first and second coupling devices connected to the adjacent sides of said first and second discrete parts.

46. The method of claim 31 wherein:
said step of assembling said tubes includes arranging said tubes to form respective first and second walls configured to form first and second discrete hollow sections of an airfoil with adjacent sections thereof being formed with multiple layers of tubes; and
removing selected ones of said tubes in said multiple layers to form respective mechanical interlocking coupling devices.

47. The method of claim 31 wherein:
said tubes are arranged with at least some of said tubes arranged in a plurality of layers.

48. A method of making an elongated composite to form a predetermined transverse contour structure and including:
selecting elongated tubes filament wound in a pattern;
assembling said tubes together in juxtaposed relationship to form a shell defining a predetermined transverse contour;
bonding said tubes together;
applying an exterior skin to the exterior surface of said shell; and
bonding said skin to said tubes.

49. A method for producing a triangular tube to resist a predetermined load on the triangular tube, comprising the steps of:
providing a mandrel having a substantially triangular cross-section;
winding the mandrel with fibers in a controlled orientation substantially paralleling the direction of a predetermined load on triangular tube;
bonding the fibers together;
curing the fibers together; and
removing the mandrel within the fibers.

50. A method according to claim 49 wherein the mandrel tapers along the longitudinal axis, forming a tapered triangular fiber wound tube.

51. A method according to claim 49 wherein the mandrel curves along the longitudinal axis, forming a curved triangular fiber wound tape.

52. A method according to claim 49 wherein the fibers are wound in a variety of controlled orientation to resist tensile, compression, and shear stresses.

53. A method according to claim 49 wherein the fibers are bonded by a pre-impregnated matrix material.

54. A method according to claim 49 wherein the pre-impregnated matrix material is an organic material.

55. A method according to claim 49 wherein the pre-impregnated matrix material is a metallic material.

56. A method according to claim 49 wherein the fibers have a substantially triangular cross-section.

57. A method according to claim 49 wherein the mandrel is removed by withdrawing the mandrel.

58. A method according to claim 49 wherein the mandrel is removed by melting the mandrel.

59. A method according to claim 49 wherein the mandrel has a predetermined section with smaller triangular cross-section along the longitudinal axis of the mandrel, wherein fibers are thicker about the predetermined section having smaller triangular cross-section.

60. An intermediate apparatus to couple a composite wing structure having a plurality of elongated thin-walled filament wound tapered triangular tubes placed co-extensively in a complementary side-by-side fashion to a composite fuselage comprising:
a predetermined number of plugs having a root end and a tip end, wherein each of the predetermined number of plugs is tapered to associate with the corresponding tapered triangular tubes;
each of the predetermined number of plugs having a flange, wherein each of the flanges are coupled to the root end of the plugs to align relative to other flanges when plugs are inserted into the corresponding tapered triangular tubes; and
the aligned flanges adapted to associate with a composite fuselage adapted to receive the aligned flanges.

61. A method of making a structure for carrying a load, comprising the steps of:
providing a chamber with gaseous reactant in the chamber;
providing a substrate within the chamber; and
tracing a laser at the substrate around a cross-section of a structure about a predetermined point along the longitudinal axis of the structure defining the structure, wherein a layer of localized deposition of fibers occur from the gas reacting due to the heat generated from the laser beam passing through the cross-sections of the structure along the longitudinal axis.

62. A method according to claim 61, wherein the cross-section of the structure varies along the longitudinal axis.

63. A method according to claim 61, wherein the gaseous reactant is carbon.

64. A method according to claim 61, wherein the structure is an airplane wing structure.

65. A filament having a high content of fibers versus the matrix material, comprising:
a filament including a plurality of cross-section of fibers and a matrix material thereinbetween the plurality of cross-section of fibers; and
said plurality of cross-section of fibers comprise at least approximately 60% of a cross-sectional area of the filament.

66. A filament according to claim 65, wherein:
the plurality of cross-section of fibers are triangular, wherein the plurality of triangular fibers are placed together in alternating side by side relationship, wherein the distance between the adjacent triangular fibers is less than approximately one tenth (0.1) of the width of the triangle.

67. A filament according to claim 65, wherein said plurality of cross-section of fibers comprise at least approximately 90% of a cross-sectional area of the filament.

68. A filament according to claim 65, wherein:
the plurality of cross-section of fibers are square, wherein the plurality of square fibers are placed together in side by side relationship, wherein the distance between the adjacent square fibers is less than approximately one tenth (0.1) of the width of the square.

69. A tie for coupling two triangular tubes made of composite structure, comprising:
a base adapted to be juxtaposed to one of the walls of a first triangular tube made of composite structure; and
a plurality of locking inserts coupled to the base at a predetermined distance apart from each other, wherein each of the locking inserts is adapted to receive a fastener.

70. A tie according to claim 69, wherein the base has edges that are beveled adapted to wedge into an inside wall the side of the two triangular tubes.

71. A tie according to claim 69, wherein the base has a trapezoidal cross-sectional shape.

72. A tie according to claim 69, wherein the base is made of same material as the first triangular tube.

73. A tie according to claim 69, wherein the locking inserts are nuts.

74. A tie according to claim 69, wherein the base has a plurality of holes corresponding to the plurality of locking inserts so that a fastener can go through the hole and tighten against the corresponding locking insert.

75. A tie according to claim 69, wherein the base has a plurality of cavity adapted to receive the plurality of locking inserts so that the plurality of locking inserts are flushed within the base.

76. A tie according to claim 69, wherein the tie is inserted between the first triangular tube and a second triangular tube that are juxtaposed at one end of each other, wherein at least one fastener is inserted through the first triangular tube and a corresponding locking insert within the first triangular tube and at least one fastener is inserted through the second triangular tube and a corresponding locking insert within the second triangular tube to couple the first and second triangular tubes together.

77. A tie according to claim 69, wherein the tie is inserted into the side of the first triangular tube and a second triangular tube is juxtaposed to the first triangular tube side by side, wherein a fastener is inserted through the second and first triangular tubes and tighten against a corresponding locking insert to couple the first and second tubes together.

78. A tie according to claim 69, wherein the base is shaped to contour the joint between two composite structures.

79. A tie according to claim 78, wherein the base substantially forms a L cross-section to contour the joint between the two composite structure that are substantially 90° from each other.

80. A tie according to claim 78, wherein the base substantially forms a flange to contour the skin of two composite structures that are substantially oblique angle with respect to each other.

81. A system for coupling two composite structures, comprising:
a tie, the tie having a plurality of locking inserts at a predetermined distance apart from each other;
a first composite structure having a first mating outer surface, a first opening within the first composite structure and adjacent to the first mating outer surface of the first composite structure, wherein the first opening is adapted to receive the first tie;
a second composite structure having a second mating outer surface, a second opening within the second composite structure and adjacent to the second mating outer surface of the second composite structure, wherein the first and second mating outer surfaces are adapted to be substantially flushed against each other; and
a first fastener adapted to insert through the first and second mating outer surfaces of the first and second composite structure respectively and tighten against a corresponding locking insert on the tie, thereby coupling the first and second composite structures together.

82. A system according to claim 81, wherein the first composite structure is a wing box.

83. A system according to claim 81, wherein the second composite structure is a leading section.

84. A system according to claim 81, wherein the first opening is a triangular shape opening.

85. A system according to claim 84, wherein the tie has a base, the base having beveled edges adapted to wedge into the triangular shape opening.

86. A system according to claim 81, further including a second tie and a second fastener, wherein the second opening is adapted to receive the second tie, wherein the second fastener adapted to insert through the first and second mating outer surfaces of the first and second composite structure respectively and tighten against a corresponding locking insert on the second tie, thereby coupling the first and second composite structures together..

87. A system for coupling two composite structures, comprising:
a tie having a plurality of locking inserts at a predetermined distance apart from each other;
a first composite structure having a first mating outer surface, a first opening within the first composite structure and adjacent to the first mating outer surface of the first composite structure, wherein the first opening is adapted to receive the tie;
a second structure having a second mating outer surface, a second opening within the second structure and adjacent to the second mating outer surface of the second structure, wherein the first and second mating outer surfaces are adapted to be substantially flushed against each other; and
at least one fastener adapted to insert through the first and second mating outer surfaces of the first and second structures respectively and tighten against a corresponding locking insert on the tie, thereby coupling the first and second structures together.

88. A system according to claim 87, further including a base having a plurality of holes corresponding to the plurality of locking inserts on the tie, the second opening within the second structure adapted to receive the base, whereby the at least one fastener runs through the hole in the base, the first and second mating outer surfaces of the first and second structures respectively and tighten against a corresponding locking insert on the tie to couple the first and second structures together.

89. A system according to claim 87, wherein the first composite structures is formed from a plurality of elongated co-extensive triangular cross-section filament wound tubes nested complementally together in juxtaposition and arranged to cooperate together in forming at least a portion of a hollow shell defining the first mating outer surface.

90. A system according to claim 87, wherein the first composite structure defines a leading section of a wing.

91. A system according to claim 87, wherein the first composite structure defines a wing box.

92. A system according to claim 87, wherein the tie has a base, the base having a trapezoidal cross-sectional shape.

93. A method for coupling two tubular composite structures together, comprising:
inserting a strip-tie within a first tubular composite structure and a second tubular composite structure, the strip-tie having a plurality of locking inserts predetermined distance apart from each other, wherein each of the locking inserts is adapted to receive a fastener;
aligning at least one fastener to any one of the plurality of locking inserts in the first tubular composite structure;
aligning at least one fastener to any one of the plurality of locking inserts in the second tubular composite structure;
inserting the at least one fastener through each of the first and second tubular composite structures; and
tightening the at least one fastener against each of locking inserts in the first and second tubular composite structures to couple the two tubular composite structures together.

94. A method according to claim 93, wherein the first and second tubular composite structures define a front and back fuselages of an airplane, respectively, both of the front and back fuselages formed from a plurality of triangular cross-section filament wound tubes nested complementally together in juxtaposition and arranged to cooperate together generally forming a circular cross-section, wherein the plurality of triangular cross-section filament wound tubes in the front fuselage substantially align with the plurality of triangular cross-section filament wound tubes in the back fuselage.

95. A method according to claim 94, further comprising:
inserting a predetermined number of the strip-ties between the aligned plurality of triangular cross-section filament wound tubes that make up the front and back fuselages, respectively; and
tightening at least one fastener on each side of the front and back fuselages against the corresponding locking insert on each of the predetermined number of the strip-ties to couple the front and back fuselages together.

96. A method for producing a strip-tie to couple two structures made of composite structures together, comprising:
forming a tubular member made from filament wound fibers;
placing the tubular member within a press, the press having an upper jaw and a lower jaw, wherein a cavity is formed between the upper and lower jaws when they are closed;
compressing the upper jaw relative to the lower jaw, whereby the tubular member is substantially conforms to the shape of the cavity between the upper and lower jaws; and
coupling a plurality of inserts to the conformed tubular member, wherein each of the inserts are a predetermined distances apart from each other.

97. A method according to claim 96, wherein the tubular member is wounded in a controlled direction substantially depending on the stress applied to the tubular member.

98. A method according to claim 96, wherein the upper jaw has beveled lips.

99. A method according to claim 96, further comprising:
drilling a plurality of holes on the tubular member aligning with the plurality of inserts.

100. A mandrel for coupling and insulating a tube made of fibers, comprising:
an insulation portion having a shaved end; and
a tie portion adapted to receive the shaved end of the insulation portion.

101. A mandrel according to claim 100, wherein the insulation portion is made of foam.

102. A mandrel according to claim 100, wherein the insulation and tie portions have a triangular cross-section.

103. A mandrel according to claim 100, wherein the tie portion has a plurality of holes predetermined distance apart from each other.

104. A mandrel according to claim 100, wherein fibers are wound around the insulation portion and the tie portion to form a fiber wound tube, wherein the fiber wound tube is insulated due to the insulation portion within the fiber wound tube and is adapted to couple to another fiber wound tube via the tie portion therein.

105. A doubler, comprising:
a doubler extends between a first and second fuselages, wherein the first and second fuselages are formed from a plurality of elongated co-extensive triangular cross-section filament wound tubes nested complementally together in juxtaposition and arranged to cooperate together in forming a hollow shell, wherein the doubler is coupled to the first and second fuselages to strengthen the joint area between the two fuselages.

106. A doubler according to claim 105, wherein the doubler is shaped like a ring.

107. A doubler according to claim 105, wherein the doubler is within the first and second fuselages.

108. A doubler according to claim 105, wherein the first fuselage is a front fuselage and the second fuselage is a back fuselage.

109. A method for forming a window within a fuselage, comprising:
cutting a window opening in a predetermined location on a fuselage formed from a plurality of elongated triangular filament wound tubes nested complementarily together in juxtaposition and arranged to cooperate together in substantially forming a hollow shell, wherein the window opening defines a predetermined number of cut out triangular filament wound tubes on a left side and a right side of the window opening, the window opening further defining a top side and a bottom side;
coupling a left window frame to the left side of the window opening, wherein the left window frame has a corresponding predetermined number of plugs adapted to insert into the predetermined number of cut out triangular filament wound tubes on the left side of the window opening;
coupling a right window frame to the right side of the window opening, wherein the right window frame has a corresponding predetermined number of plugs adapted to insert into the predetermined number of cut out triangular filament wound tubes on the right side of the window opening;
coupling an upper window opening to the top side of the window opening; and
coupling a lower window opening to the bottom side of the window opening.

110. A method according to clam 109, further comprising:
fastening the corresponding predetermined number of plugs on the left and right window frames to the predetermined number of cut out triangular filament wound tubes.

111. A method according to clam 109, further comprising:
bonding the corresponding predetermined number of plugs on the left and right window frames to the predetermined number of cut out triangular filament wound tubes.

112. A method according to clam 109, further comprising:
sealing the left window frame, the right window frame, the upper window frame, and the lower window frame to the window opening.

113. A method for providing a cover for a window in a fuselage of an airplane, comprising:
coupling a pair of rails along a longitudinal axis of a fuselage, wherein a window is between the pair of rails; and
sliding a cover within the pair of rails along the longitudinal axis of the fuselage, wherein the cover substantially covers the window.

114. A method according to claim 113, further comprising:
stopping the cover when the cover is substantially juxtaposed to the window.

115. A method according to claim 113, wherein the pair of rails runs across a plurality of the windows arranged longitudinally along the fuselage, wherein a corresponding cover is provided for each of the plurality of windows to slide between a first position and a second position, wherein in the first position the cover substantially covers the window and in the second position the cover is adjacent to the window.

116. A wing tie for coupling a left wing and a right wing together and inspecting therein, comprising:
a base having a base opening;
a left side adapted to couple to a mating surface of a left wing, wherein the left side has a left side opening; and
a right side adapted to couple to a mating surface of a right wing, wherein the right side has a right side opening, whereby an operator can inspect the left and right wings through the base, left, and right openings.

117. A wing tie according to claim 116, wherein the wing tie has three sides, the base and the left and right sides to substantially define a triangular shape cross-section.

118. A wing tie according to claim 116, wherein the left and right sides converge to define a tip, the mating surfaces for the left and right wings having a top side and a bottom side, wherein the top side of the left and right wings are coupled to each other along the tip of the wing tie.

119. A wing tie according to claim 118, wherein the left and right wings are formed from a plurality of elongated triangular filament wound tubes nested complementally together in juxtaposition and arranged to cooperate together in forming a wing, wherein predetermined number of triangular filament wound tubes have a plug therein, wherein each plug has a step-tab adapted to couple across the top surface of the other wing.

120. A wing tie according to claim 119, wherein the plug has a predetermined width, wherein the step-tab is about one-half the width of the plug so that the step-tab from the left wing may lay adjacent to the step-tab of the corresponding plug in the right wing.

121. A system for coupling a bulkhead to a fuselage, comprising:
a bulkhead formed from a plurality of curved triangular filament wound tubes nested complementally together in juxtaposition and arranged to cooperate together in substantially forming a concave shell;
a fuselage formed from a plurality of elongated triangular filament wound tubes nested complementally together in juxtaposition and arranged to cooperate together in substantially forming a cylindrical shell; and
a predetermined number of plugs having a curved portion substantially adapted to insert into the curved triangular filament wound tubes in the bulkhead and a substantially a straight portion adapted to insert into the elongated triangular filament wound tubes in the fuselage, wherein the plug is adapted to couple to the triangular filament wound tubes in the bulkhead and the fuselage.

122. A system according to claim 121, wherein the bulkhead and the fuselage have an outer surface, wherein each plug on the bulkhead has a step-tab adapted to couple across the top surface of the fuselage, and each plug on the fuselage has a step-tab adapted to couple across the top surface of the bulkhead.
